(19) United States
(12) Patent Application Publication
(10) Pub. No.: US 2026/0370179 A1
(43) Pub. Date: Nov. 19, 2026

(54) IMPROVING POWER GENERATION OF PV SOLUTIONS

(71) Applicant: Solbuz Inc., Gizo (IL)

(72) Inventors: Yitzhak Liechtenstein, Zichron ya'acov (IL); Ofer Avni, Gizo (IL)

(73) Assignee: Solbuz Inc., Gizo (IL)

(21) Appl. No.: 19/121,427

(22) PCT Filed: Nov. 15, 2023
(86) PCT No.: PCT/IB2023/000727

§ 371 Date: Apr. 16, 2025

Related U.S. Application Data
(60) Provisional application No. 63/384,433, filed on Nov. 20, 2022.
(60) Provisional application No. 63/538,517, filed on Sep. 15, 2023.

(30) Foreign Application Priority Data
Nov. 15, 2023 (WO) PCT/IB2023/000727

(51) Int. Cl. H02S 20/32; H02S 40/22

(52) U.S. Cl. CPC H02S 20/32; H02S 40/22

(57) ABSTRACT

A PV solution to generate electrical power, which increases significantly (sometimes doubling) the power generated on a given deployment surface by overcoming the self-shading effect and improve effective PV coverage. The approach to overcoming the self-shading effect problem is based initially on spreading the shadow (and the light) on the PV cells in a way that will maximize total electricity production, supported by enabling electrical connections, thus avoiding bottlenecks of the power generation. Optical solutions to eliminate or minimize the shadow, electrical solutions and structural solutions are also provided, as well as their manufacturing technics.

### BACKGROUND

A photovoltaic (PV) panel is used to convert sunlight into electrical energy. A single PV absorption component is known as a PV cell. An individual PV cell is usually small, typically producing between 1 to 5 watts of power. These cells are typically made of different semiconductor materials and are often less than the thickness of four human hairs. In order to withstand the outdoors for many years, cells are sandwiched between protective materials in a combination of glass and/or plastics. PV panels around the world are mounted in a tilted manner with an angle towards the sun, (i.e. towards the south on the northern hemisphere and towards the north in the southern hemisphere), so the angle “alpha” between the PV surface and the sun ray is closer to 90 degrees as much as possible on the average throughout the year (i.e. maximizing photons flux and minimizing reflection throughout the year). The further the deployment is away from the equator, the larger is the required tilt.

This tilted structure causes the PV panels to cast shadows on their surroundings. These shadows can affect the performance of other PV panels if positioned in their vicinity. The larger the tilt-the larger is the shadow that can be cast at obtuse sun angles. Obtuse sun angles as used herein means angles of the sun during times when the sun is low in the sky (e.g. mornings and evenings).

Shadowed PV cells are known to create a significant problem because it turns the PV cell into a resistor with very high resistance, which is called the shading effect. Shading effect occurs when a photovoltaic system does not receive the same amount of incident irradiation level throughout the system. In these conditions, the PV cells receiving a lower level of irradiance can absorb power instead of producing it. As a result, when a PV cell is fully shadowed, it blocks most of the power of other PV cells which are connected in series, even though the other PV cells could otherwise function properly. Thus, a few shadowed PV cells may block most of the power for the whole PV panel and even the whole array of PV panels connected in series. This is the shading effect. However, if a partial shadow is cast on a standalone PV cell, it only reduces the power it generates proportionally to the percentage of the shadow cast on the PV cell out of the total surface size of that PV cell, and does not block it. The reason is that the current between the layers of a PV cell is generated in parallel throughout the whole lighted area of the PV cell.

For example, PV panels on a flat deployment surface, are positioned with a tilt facing sun, (i.e. towards the south on the northern hemisphere and towards the north in the southern hemisphere), creating a better angle facing the absorption direction (this will be defined later herein), as depicted in FIG. 1. Due to this typical tilting angle (131), such PV panels are casting shadows on their area, thus neighboring rows of PV panels are located remotely from each other in order to avoid this self-shading problem of the system in obtuse sun angles. One of the common practices is to position the rows of PV panels distant from each other enough, so there will be no shadow cast by one row on the next row at the peak of the winter, usually between 9:00 am to 3:00 pm (i.e. no self-shading).

This gap between the PV panels (118) is a wasted space that doesn't produce energy during times when the sun is high in the sky like Zenit, and a large percentage of the radiation is arriving at this gap instead of the PV surface, and its energy is lost due to it, as depicted also in FIG. 1. If this ‘wasted space’ between the PV panels reaches 40% of the roof surface, the lost energy during Zenit for that deployment surface can reach up to 40%, depending on the geographic latitude of the deployment. The farther the PV panel is from the equator (in term of latitude), the larger is the typical tilting angle. Zenit as used herein means sun position around its highest daily point in the sky (e.g. noon).

FIG. 1 shows a side view of PV panels (107) mounted on a deployment surface (111) with an infrastructure (212) that positions the PV panel in a typical tilting angle (131), to better absorb the sun light beam (100). There is a gap between the PV panels (118) to avoid shading of one PV panel on another PV panel in obtuse sun angles (i.e. self-shading).

Around Zenit all the photons from the sun (101) that collide with the gap (118) miss the PV panels and are lost for potential power generation. The angle alpha (106) mentioned earlier is the angle between the PV panel (107) and the sun light beam (100).

When the shading effect occurs, most of the energy from most of the photons that do collide with the PV panels connected in a series, is also lost since the power generated will drop dramatically and the power they could have generated will be lost.

Current solutions to the shading effect include using by-pass diodes that can by-pass two rows of PV cells in a PV panel when one or more of these PV cells are shaded, and optimizers which restrict the power loss to the shaded PV panel so it does not impact all of the PV panels that are connected in series. These solutions are not very effective if some PV panels suffer from self-shading during most of the day, so the power production will drop significantly if the gaps between rows of PV panels are decreased.

The above indicates that there is a need for a system that will overcome the shadow effect which is resulted from self-shading, and will enable to condense the rows of PV panels and increase power generation per a given deployment surface or footprint.

Other problems with current PV solutions that such invention should address if possible:

Current solutions of large PV panels are not able to fully cover a tilted roof's surface area if it is not a perfect rectangular shape (see FIG. 2). Even with perfect rectangular roofs, some space may be wasted when the dimensions of the roof do not perfectly match a multiple of the PV panel size. One can work with smaller PV panels, even as small as the size of roof tiles, but this would significantly increase the infrastructure required, the number of connections and the installation process required to install and connect them together during deployment.

FIG. 2 demonstrates how a triangle roof can be covered with rectangular flat PV panels attached to the roof (109) thus a lot of space is wasted (110). It also demonstrates how heavy, large infrastructure (212) is needed to tilt a PV panel (107) on a flat roof in the right angle towards the absorption direction (136) (absorption direction is the best fixed direction to absorb the sun radiation on aggregate throughout a whole year by minimizing reflection as well as maximizing the flux of the photons colliding with the PV surface). The shadow (171) is cast by the rows of PV panels (107) on rows of PV panels behind them in spite of the gap between the rows (118), when the sun light beam (100) is arriving from obtuse angles.

Existing solutions that overcome the problem of covering the whole roof regardless of its shape, are roll up solutions which enable to lay continuous, flexible sheets of PV material on the roof without expensive infrastructure. However, since these solutions are mounted parallel to the roof, their angle towards the sun is not designed to be adjusted to the absorption direction, especially when the roof is not facing the optimal orientation towards the sun, as shown in FIG. 3.

FIG. 3 demonstrates how a flat PV panel (109) that is attached to a north facing roof (left side of the figure) in the northern hemisphere receives the sun radiation in a very obtuse angle, which means that the flux of energy that reaches the PV panel is very small and most of that radiation is reflected back (115) to space. Thus, the efficiency of that PV panel is very low. The same is true for flexible PV sheets that are attached to such a roof (e.g. roll up solutions) or PV tiles. For the sake of this document, when mentioning PV cells or PV surface, both mean any type of PV solution technology, including regular PV cells made of silicon or any other material, such as roll up PV sheets, thin film, PV tiles, perovskite, any PV material sprayed on any surface or any combination of them.

PV cells are also sensitive to high temperature. They tend to heat up significantly due to several reasons, including among others the protective glass and sealing materials, sometimes called capsulation material (e.g. EVA) that are aimed to protect the PV panel from oxidation and degradation during its life time, as well as act as shock observers during shipment and during problematic weather conditions (e.g. hail). Studies show that a PV panel can heat up by 20 degrees Celsius above the air temperature on average when exposed to the sun, and the PV cell is losing 1%-2% of its efficiency on average for every 3 degrees Celsius increase of its temperature.

The protection means mentioned above also result in significantly increasing the weight of the PV panels, that together with the tilting creates a need for a massive infrastructure to place and secure them, especially in strong winds and when they are installed on part of the roof that doesn't face the absorption direction, and one needs to elevate the infrastructure accordingly in order to better face the sun, increase their photon flux and reduce reflection of the light. See FIG. 3 for the problem of non-elevated PV panels, and see in FIG. 4 for the large infrastructure (212) that is needed to fix it.

FIG. 4 demonstrates the large infrastructure (212) that is required to deploy a PV panel (107) to face the absorption direction (136) on a northern roof (in the northern hemisphere).

Adding a dynamic sun tracking capability to these PV panels does increase power generation but also results in even larger and more massive infrastructure and very robust engines per PV panel which are needed to allow tracking capabilities. These significant disadvantages make installation impractical on many roofs. These tracking capabilities also come with a cost of larger wasted space between them. For a PV panel not to cast a shadow on neighboring panels in times of low sun angles, these tracking PV panels are positioned even further apart from each other relative to static PV panels, as depicted in FIG. 5, and the space between is where a lot of energy is wasted when the sun is not in obtuse angles.

FIG. 5 demonstrates the robust infrastructure (117) required for tracking PV panels (116), as well as the large gap (118) required between the PV panels in order for one PV panel not to cast a shadow on other PV panels in obtuse angles of the sun light beam (100) Another problem to mention here is reflection. Because these PV panels are usually protected by a glass cover, it creates high reflection in obtuse angles of the sun light beam (100), where a major part of the radiation is reflected and does not penetrate the glass.

Anti-reflection materials can reduce this issue only to a minor extent, and they also wear off after a few years. Strong reflection also occurs from the inner side of the glass where the light moving from the glass towards the PV cells through a layer of air, and significant part of it is reflected back in accordance with the Fresnel equation if they are not perfectly optically coupled.

A solar cell panel, PV panel, or solar panel, is an assembly of photovoltaic solar cells, usually mounted in a frame (usually rectangular). Solar panels capture sunlight as a source of radiant energy, which is converted into electric energy in the form of direct current (DC) electricity.

### SUMMARY

This invention describes a system and a method for a PV solution to generate electrical power, which increases significantly (sometimes doubling) the power generated on a given deployment surface by overcoming the self-shading effect and improving effective PV coverage.

The approach to overcoming the self-shading effect problem is based initially on spreading the shadow (and the light) on the PV cells in a way that will maximize total electricity production, supported by enabling electrical connections, thus avoiding bottlenecks of the power generation. Optical solutions to eliminate or minimize the shadow, electrical solutions and structural solutions are also provided, as well as their manufacturing technics.

### BRIEF DESCRIPTION OF THE DRAWINGS

FIG. 1 shows how many photons are missing the PV Panels in a typical deployment on a flat roof.

FIG. 2 demonstrates how many photons are missing the PV Panels in a typical deployment on a triangle roof and flat roof.

FIG. 3 demonstrates the problem in placing PV panels on a northern roof in the northern hemisphere.

FIG. 4 demonstrates the large infrastructure that is required to deploy a PV panel to face the absorption direction on a northern roof (in the northern hemisphere).

FIG. 5 demonstrates the infrastructure and the large gap in a typical deployment of tracking PV panels.

FIG. 6A shows a strip of PV Cells mounted on a flex PCB strip.

FIG. 6B shows a cross section of an example of a continuous sealed PV module (156) prior to mounting it in a case.

FIG. 7A shows the cross section of the case which is comprised of a transparent plastic in a V-shape.

FIG. 7B shows a cross section of another version of a case by splitting the covered V-shape into 2 parts.

FIG. 8A show a similar positioning system as in FIG. 7B at a 3-dimensional perspective.

FIG. 8B shows a zoom in on part of a cross section of the sealed PV module mounted on the positioning system.

FIG. 8C shows units of another V-shape profile (183) connected during implementation.

FIG. 9A shows an exploded upside-down view of a structure example of a continuous PV cell strip.

FIG. 9B shows the PV cell strip (258) assembled and its ability to bend.

FIG. 9C shows a lamination machine in which PV cells are connected.

FIG. 9D demonstrates how a strip of continuous sealed PV module can be cut between any two vertical groups of PV cells.

FIG. 9E demonstrates how a strip of continuous sealed PV module based on thin film can be cut between any two vertical groups of PV cells.

FIG. 9F shoes how a connector is connected to the strip of continuous sealed PV module.

FIG. 9G shows how two flat connectors connect two continuous profile modules where needed.

FIG. 9H shows a continuous capsulation sandwich with glass tiles whereas some of its layers are wrapped around the edges prior to the lamination in order to better protect the edges.

FIG. 91 demonstrates another type of lamination machine that provides longer pressing time and a method to manufacture the folding solution.

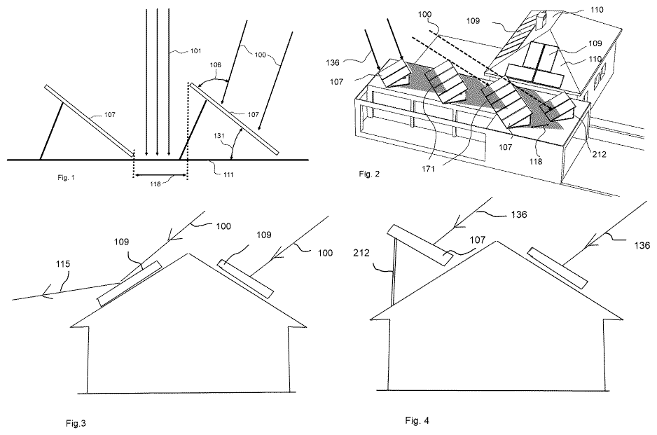

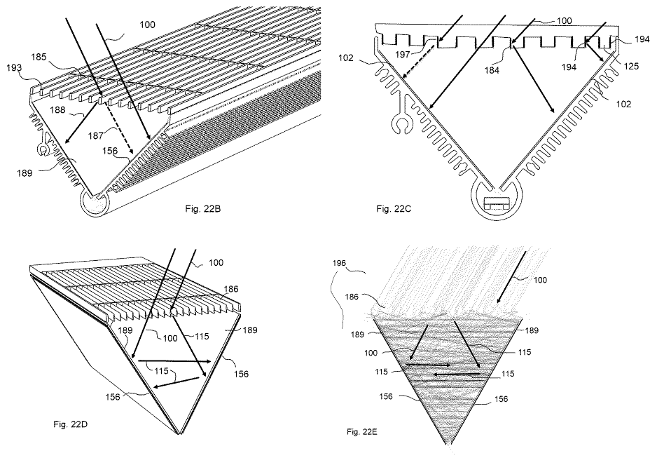

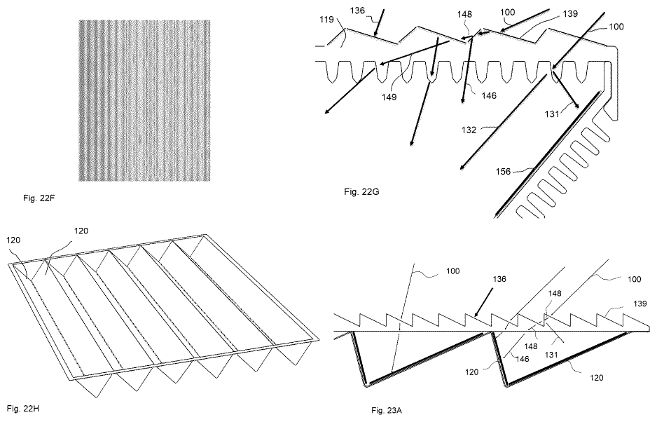

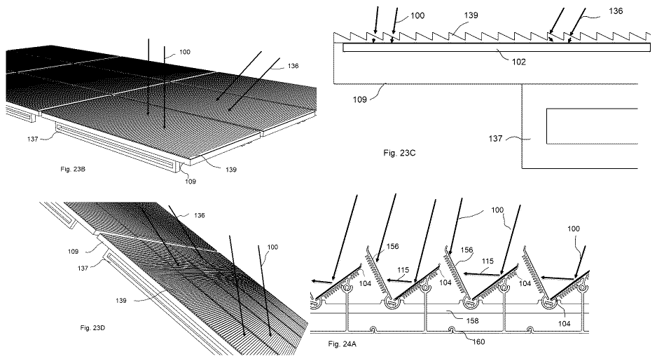

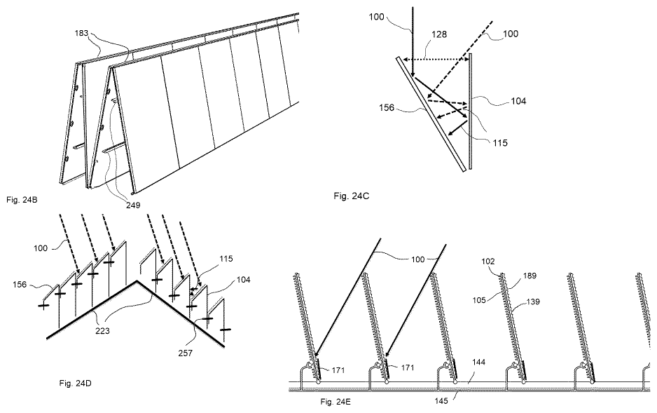

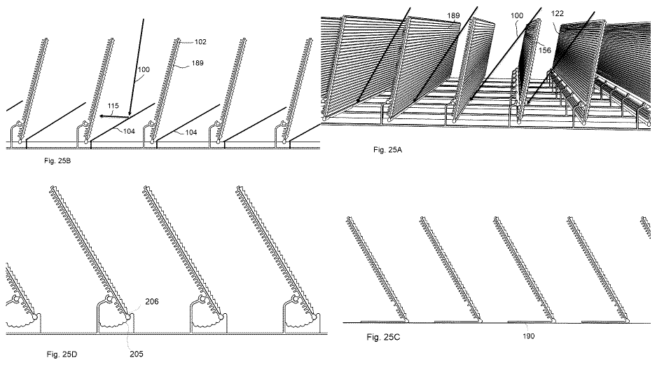

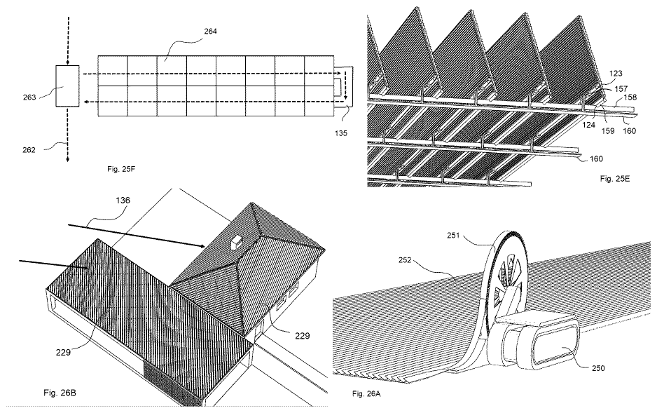

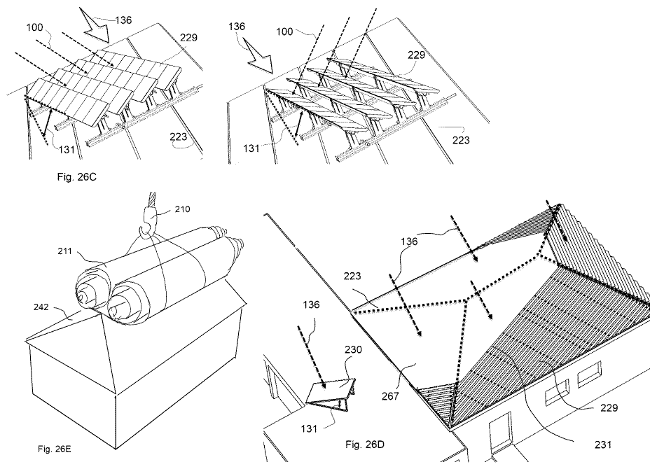

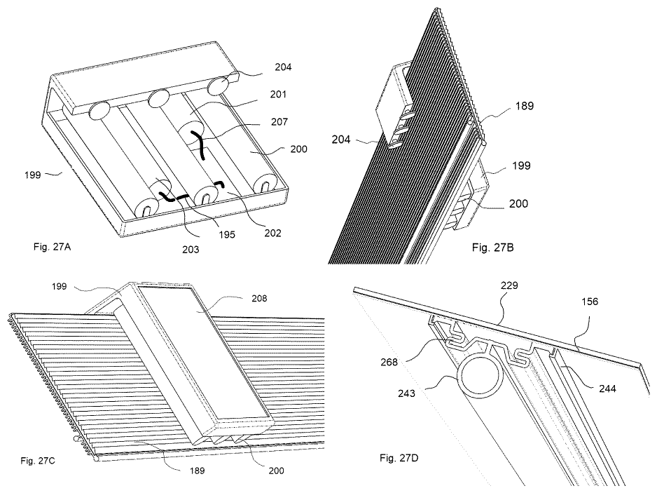

FIG. 9J shows a zoom in of the folding rolls (276), which fold the ETFE protecting layer (270) around the PV cells (102) and its EVA layer (154).

FIG. 10 shows a cross section of a V-shape profile with a cooling system.

FIG. 11 shows a cross section view of how an array of V-shape profiles is mounted on the base of the system (160) in a way that enables it to change direction in different settings.

FIG. 12 shows a cross section of the same system as FIG. 11, but at a different angle.

FIG. 13 shows how the system accommodates different roof directions and slopes.

FIG. 14 shows an example of possible settings of the V-shape profiles on a northern roof.

FIG. 15A shows a cross section of an array of optical elements in the top cover.

FIG. 15B shows a 3-dimensional drawing of the lengthened optical elements on the internal side of the top cover.

FIG. 16 shows a cross section of another type of cover with raised walls.

FIG. 17 shows the round optical elements on the internal side of the top cover at a different angle.

FIG. 18A shows the top cover of the positioning system which includes both texture objects.

FIG. 18B shows how the light arriving to one optical element can light up another PV cell nearby.

FIG. 19A shows how the system can be deployed in a way it tracks the changes of the short-term absorption direction.

FIG. 19B shows in an exploded view how a DIE diode (261) can be connected.

FIG. 20A shows how the sun light beam creates equal size shadows on all PV cells.

FIG. 20B shows a 3-dimensional drawing of FIG. 20A.

FIG. 20C shows a solution based on continuous profile module with a flat PV surface.

FIG. 21A shows how the sun light beam creates equal size shadows on all PV cells.

FIG. 21B shows more details of the flat profile.

FIG. 21C demonstrates an array of this new type of PV panels.

FIG. 21D shows a deployment method in which regular PV panels with some addition can also overcome the self-shading effect.

FIG. 21E shows possible deployments of the new PV panels on a curved surface.

FIG. 22A shows how the sun light beam is trapped between 2 semitransparent lenses.

FIG. 22B shows a different type of small optical elements, partially transparent.

FIG. 22C shows a cross section of another type of semitransparent optical element.

FIG. 22D shows how the curved mirrors are spreading the light beam across the sealed PV module.

FIG. 22E shows a cross section of the software simulation results of such a solution as in 22D.

FIG. 22F demonstrates the photon distribution across one of the PV cells in the V-shape profile.

FIG. 22G demonstrates how a top cover is manufactured with repeating elevation slopes.

FIG. 22H shows a few positioning systems that is manufactured by pressing one sheet of aluminum.

FIG. 23A shows how a cover with elevated slopes is mounted on a positioning system.

FIG. 23B shows an example for a flat PV panel on infrastructure with elevation slopes.

FIG. 23C shows a zoom-in of FIG. 23B, where the PV cells are inside the PV panel.

FIG. 23D shows a PV panel on a slope that is facing opposite to the absorption direction.

FIG. 24A shows a cross section of a V-shape profile whereas its right V wall is a mirror.

FIG. 24B shows how an array of connected V-shape profiles can be folded together for shipping.

FIG. 24C shows a one-sided V-shape profile that is trapping the light.

FIG. 24D describes a static V-shape profile structure which can be adjusted to different roof slopes without a rotation capability, since it traps the light as depicted in FIG. 24C.

FIG. 24E shows a cross section of a rigid profile.

FIG. 25A shows a 3-dimensional drawing of a similar system as in FIG. 25.

FIG. 25B shows a cross section of a static version of the rigid solution.

FIG. 25C shows another example of a cross section of a static rigid profile.

FIG. 25D shows an example of a cross section of the rigid profile array which each of its rigid profiles can be set separately to the preferred direction.

FIG. 25E shows a close-up of the bottom side of the rigid profile.

FIG. 25F shows the electric current flow through two continuous profile modules.

FIG. 26A shows a robotic machine that deploys flexible continuous profile module.

FIG. 26B demonstrate how flat profiles can be positioned on different slopes of the roof.

FIG. 26C explains how a tilted roof (223) is used to enable tracking around the typical tilting angle (131).

FIG. 26D is illustrating a method to deploy south-facing diagonal profiles at the typical tilting angle on a tilted roof.

FIG. 26E shows how a carpet of continuous profile modules can be deployed by a crane.

FIG. 27A shows an example for a cleaning robot for continuous profile modules.

FIG. 27B shows the cleaning robot (199) on rigid profile from the back side.

FIG. 27C shows the cleaning robot with a dedicated PV panel that generates power for the robot.

FIG. 27D shows the flat profile with built-in flexibility to absorb some of the impact of hail.

### DETAILED DESCRIPTION

The solutions described herein enable condensing PV panels and PV cells more than what has been done in the prior art without hurting their performance due to self-shading. At some point, such condensing enables having a larger PV surface than the footprint (i.e. projection) of that surface, creating 3-dimensional PV structure.

A 3-dimensional PV structure is a PV structure which has a total PV surface size that is larger than its footprint (i.e. projection) by at least 1% in any possible tilting. (Footprint is measured when the collimated sun light beam is perpendicular to the flat surface on which the projection is cast). 3%, 5%, 10% and 20% were also considered for this definition.

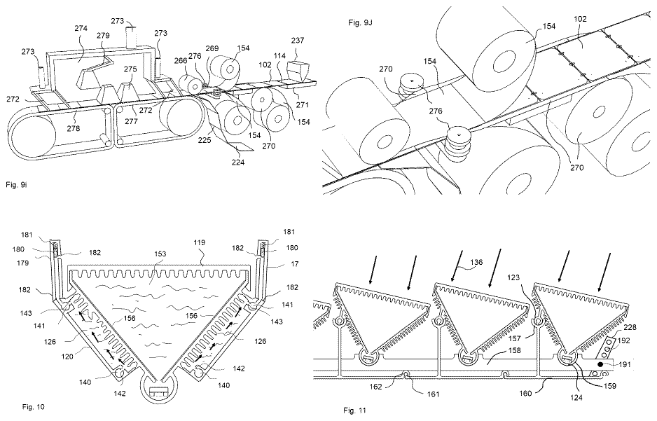

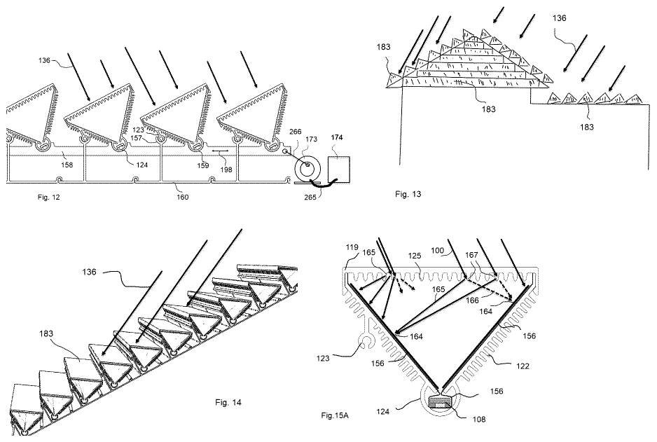

An example description of such a system is enclosed in the first part of this invention. Any given PV cell, including off the shelf PV cells, or PV absorption technology can be used for this invention. PV cells (i.e. PV cells or PV surfaces or any other material that absorb photons and turn them into electrical power, including bifacial PV cells) are mounted in couples on a flex PCB (flexible printed circuit board) strip one after the other and side by side, creating a continuous strip of 2 PV cells, each couple of PV cells in a cross section of the strip are connected in parallel, and all the couples are connected to each other in series, an example for which is detailed in FIG. 6A. In this document, the phrase “connected in parallel” means connected electronically in parallel, and the phrase “mounted in parallel” means mounted geometrically in parallel.

FIG. 6A shows a sealed PV module (156) which is a strip of PV Cells (102) which are mounted on a flex PCB (152). Each two PV cells in each cross section of the strip are connected in parallel (280) though a conductor (114) with a bypass diode (108) connected in parallel to both of them through a central conductor (150). The couple PV cells in each cross section are connected to the next couple in series, that can reach any length. A place for attaching an electrical connector (113) is available between each 2 pairs of PV cells for either the plus connection or for the minus connection, so wherever the strip is cut off between two PV cells there is a place for a connector. The same functionality can be achieved without the flex PCB in many other ways, such as by using metal conductors which are mounted with the PV cells between two attached layers of EVA (ethylene vinyl acetate).

The sealed solution of the flex PCB with the PV cells that includes EVA layer for the purpose of sealing the PV cells and the conductors is shown in a cross section in FIG. 6B. The strip can also be made by any other material with similar optical qualities, appropriate flexibility and durability like combinations of PET and EVA, as well as by spraying PV material on any flexible surface with metal conducting strips connecting between the PV cells. Perovskite and thin film are also an optional PV technology for this. When referring to a cross section of the solution as used herein the meaning is a cross section where there are PV cells or PV surface, and not to the connection points between them. The sealing can also be done with a transparent silicon or similar material at a later stage that will also provide better optical coupling between the covering glass and the PV cell, to reduce reflection and improve efficiency.

FIG. 6B shows a cross section of an example of a continuous sealed PV module (156) prior to mounting it in a case. The sealed PV module is comprised of the PV cell (102) attached to a flex PCB (152) underneath, with transparent EVA layer (154) on top of it, both are glued to each other all around the PV cell, like in points (155) and the EVA is attached tightly to create optical coupling with the PV cell. A bypass diode (108) is also sealed inside this sealed PV module between the 2 PV cells in each cross section. It can be connected in parallel to any single PV cell, or to every couple of PV cells as in FIG. 6B, or to every few PV cells, to overcome the shading effect from any sporadic shadows. Sealed PV modules can also be manufactured with only one PV cell at any vertical cross section of the row of PV cells or any number of PV cells, whereas if the group of PV cells in a vertical cross section are more than one, they are connected in parallel (to be called vertical group or column), and the columns are connected in series to each other. The sealed PV module can be also covered by any protective transparent material, such as Ethylene tetrafluoroethylene (ETFE).

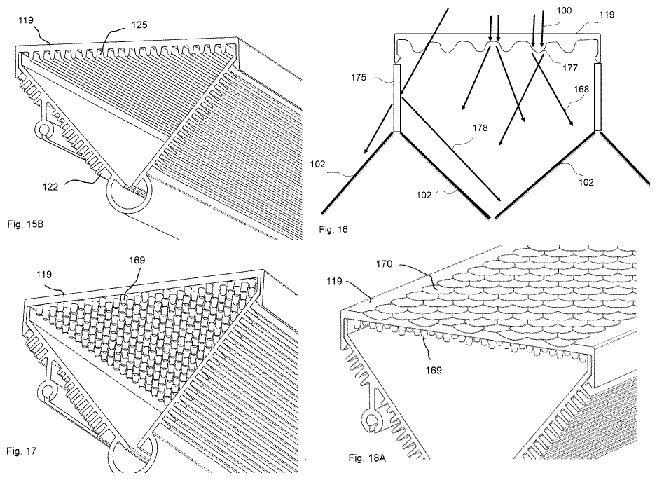

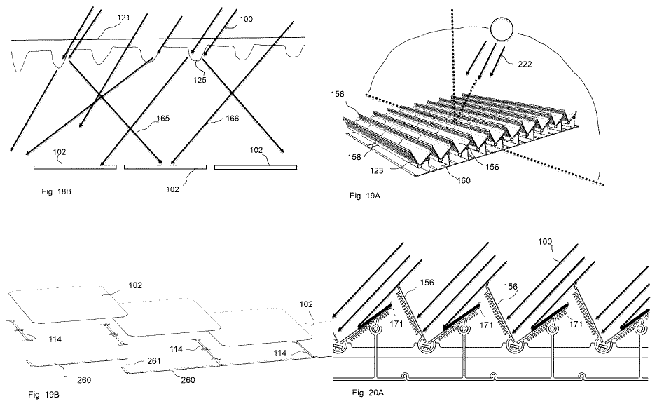

A lengthened case, a cross section example of which is detailed in FIG. 7A, can be manufactured by using an extrusion method from materials such as polycarbonate or acryl or glass or any other material that remains transparent to light for years under tough weather condition and maintain long product life time. It can also be manufactured with any other manufacturing technique.

FIG. 7A shows the cross section of the case which is comprised of a transparent plastic in a V-shape (127) which holds the sealed PV module (156) in a V-shape. This case includes an integral cover (121) which is made of the same material thus is also transparent to the sun light beam (100). There is an option to glue the sealed PV module after inserting it to the to the V-shape by using a glue that is activated only with special light for example.

There is also an option to split the positioning system into two parts, the bottom V-shape part, made of aluminum or any other material that can transport heat efficiently to the outside air and thus cool the PV cells, and a cover which is made of transparent material (e.g. plastic or glass), as detailed in FIG. 7B. This way the system also decreases the heating problem, that is detailed in the background, and can further increase by about 7% the efficiency of power generation by the PV surface during hot weather conditions.

FIG. 7B shows a cross section of another version of a case by splitting the covered V-shape into 2 parts: The positioning system (120), which is the bottom part, is made of aluminum or any other heat-transfer material with cooling ribs (122) on which the sealed PV module (156) is mounted, and a separate top cover (119) which is transparent to light. This cover can also have optical elements (125) which diffuse or divert the sun light beam (100) across the sealed PV module (156) and especially to areas on the PV surface with lower exposure or no exposure to direct sun light beam (100), that is a result of its angle relative to the sun (in this example in FIG. 7B it's the PV cell on the right). The positioning system also has a rotating axis (123) that is used to tilt the positioning system and an angle setting axis (124) that is used afterwards to set the angle in which the positioning system is mounted. The diodes (108) are stored within the angle setting axis (124), so it doesn't cast any shadow on the rest of the sealed PV module. The entire profile, including the positioning system, the cover and the sealed PV module is called the V-shape profile (183). This V-shape profile is an example of a 3-dimensaniol PV structure that in some scenarios generates more power than a flat PV cell of the same footprint. Our test shows that for a V angle (128) of 80 degrees, this solution generates 15% more power per square meter than flat PV cells when the cover (119) is facing the sun. Some of the extra power is a result of absorption of light that is reflected from one PV cell and absorbed by a PV cell on the other side of the V-shape. The V-shape profile has many versions, some of which will be described in this document.

This V-shape profile is actually a connected row of similar units (which means the same units that might slightly differ due to manufacturing or assembly inaccuracies and fault tolerances) as described above, which can reach any desired length. Mounting these long V-shape profiles in parallel, side by side, enables a complete coverage of any deployment surface. This V-shape profile is only one type of a continuous profile module. A continuous profile module (sometimes called just “profile” or just “module”) is a system with PV cells which has similar cross section throughout the lengthened dimension of its structure, which can reach any length, with similar orientation. When it is comprised of similar units (e.g. PV cells) connected in a row, then except for the connection between the units their cross-section mostly looks the same. Similar orientation as used herein means orientation which is about the same but might slightly differ due to inaccuracies and fault tolerances of the structure, the system, the deployment surface or due to the implementation or due to the assembly process, or any other reason. As a general rule, up to 5 degrees error can still be considered similar orientation, although in an ideal design it should be less than 1 degree. This definition also applies for using the phrase “similar direction” as used herein. Typically, a continuous profile module will be at least 3 meters long, but down to 1.5 meters can also be used. Also, the typical width of such profile would be less than 0.5 meters, although 1 meter can also be used. Typically, each continuous profile module within the array of continuous profile modules can be connected to the deployment surface or to the mounting structure or to the base units either continuously or periodically along its lengthen dimension. Connected along its lengthen dimension means connected continuously or periodically along the front of the PV cells, or along the back of the PV cells, or along the lengthen sides of the continuous profile module but without holding it at the edges of the lengthened dimension of the continuous profile module, so there is no need to cut it in order to hold or support it. The mounting structure can be attached close to the deployment surface, or distant from it of up to 1 meter. In other scenarios 2- and 3-meters distance can also be possible. Typically, the PV cells in a continuous profile module will be positioned at least 5 degrees away from being parallel to the deployment surface they are mounted on.

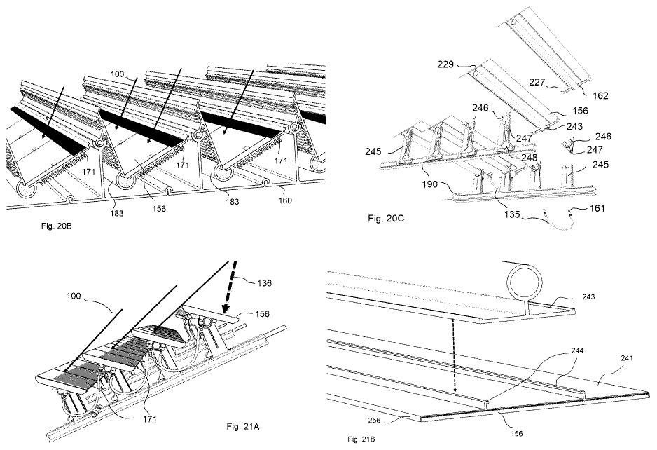

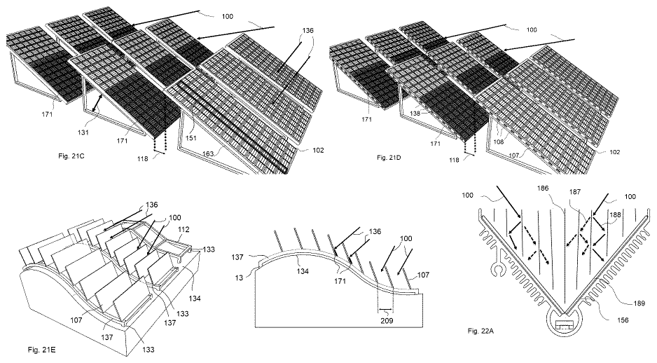

FIG. 8A show a similar positioning system as in FIG. 7B at a 3-dimensional perspective.

FIG. 8B shows a zoom in on part of a cross section of the sealed PV module (156) mounted on the positioning system (120). The mounting can be done by using a type of glue characterized by good heat transition for example.

The connection between the similar units can be executed during production or during deployment preparation or during implementation. Example for a continuous profile module which is connected during implementation can be seen in FIG. 8C.

FIG. 8C shows units of another V-shape profile (183) connected during implementation by inserting the male connector (129) to the female connector (130), whereas the connector includes a mechanical part and an electronic part that connects the connection points (113) of the conductive lines on the flex PCB.

Even in cases when the continuous profile module is assembled during manufacturing, in many cases, shipping it to the implementation site requires to build it shorter than the deployment surface it is supposed to cover. In these cases, there is a need for such a connector as in FIG. 8C.

There is also an option to roll the strip of the sealed PV module and bring it to the deployment surface as is, connect the base profiles and the infrastructure to the deployment surface and only then attach the sealed PV module. This is also possible if the cover of the sealed PV module is not flexible like ETFE. In such a case it is possible to protect the sealed PV module with a glass tile attached on top of each PV cell, a protection that will still enable to roll the strip since between the PV cells some flexibility can remain, as depicted in FIG. 9A.

FIG. 9A shows an exploded upside-down view of a structure example of a continuous PV cell strip (258) which is actually a sealed PV module as described before with one row of PV cells, that has flexibility in spite of being protected by glass tiles (224). This is a flat type of a continuous profile module (and not 3-dimensional like the V-shape profile). The layers can include the glass tiles (224) (one per each PV cell) which have silicon sealing between them (225). The glass tiles are optically coupled with to PV cells (102), and the PV cells are connected between them with flexible conductors (114) and are capsulated between 2 EVA layers (154). A back sheet (226) is attached at the back in order to provide strength to the strip and can be transparent as well. The flexibility of the conductor tabs (114) and the sealing silicon (225) enables to bend and roll the entire PV cell strip, as depicted in FIG. 9B. A glass tile can also cover more than one cell.

FIG. 9B shows the PV cell strip (258) assembled and its ability to bend, in spite of the glass tiles (224) due to the flexibility of the connecting tubs (114) and the sealing silicon (225).

This PV cell strip can be manufactured at any length in many ways, one of which include manufacturing machine based on continuous roll lamination, an example for which is detailed in FIG. 9C.

FIG. 9C shows a lamination machine in which PV cells (102) are connected by conducting tabs (114) are wrapped by EVA (154) for encapsulation, while the back sheet (226) and glass tiles (224) are glued through the lamination process, creating an endless, continuous and flexible strip of sealed PV module covered with glass tiles out of the capsulation sandwich (which means all the layers of the lamination before they are heated and glued). The machine itself include soldering iron (237) to connect the PV cells (102) and the conducting tabs (114), lamination rolls (238), pushing rolls (239), and the outcome is the strip roll (240) of the PV cell strip (258). It is also possible to use continuous flexible material instead of the glass tiles, such as ETFE. The manufacturing machine can also be based on an oven which also creates pressure while heating the capsulation sandwich, instead of roll-based lamination. In such an oven solution, a section (or part) of the continuous capsulation sandwich is moved into the oven, the oven heats it up and press on it, and then the next section of the continuous capsulation sandwich is moved into the oven and the previous section, which is now a ready as connected PV cell strip, is moved out of the oven. The manufacturing machine can generate a very long roll of PV cell strip (240) or a shorter length of PV cell strip (258) according to a specific need.

It is also possible to glue the continuous capsulation sandwich without heating and compressing with appropriate materials, which may or may not include a vacuum chamber.

If the flat profile utilizes transparent material which is not glass, such as polycarbonate, PET or ETFE, it is easy to manufacture it in any desired length. However, a glass cover is needed if durability and long product life is required. The flat profile can be covered with glass pieces that will cover several PV cells as part of the sealing and coupling process. A glass piece can be a few meters long and assembled without breaking. However, this creates some challenges since in order to cover the length of the roof there might be a need in several glass covered profiles in several different lengths that require many connectors between them. There is an advantage in a continuous manufacturing process that can provide the continuous profile module with glass cover at any desired length without connectors in the middle. One of the options is to cover the sealed PV module with a glass tile mounted on each PV cell on one side while the other side of the PV cell is attached to strong sheet of plastic of some type, such as PET, polycarbonate or ETFE, to maintain the strip well connected as was detailed in FIG. 9A. The connection points between the glass tiles (224), which is sealed with a sealing material such as silicon (225), have some flexibility so the strip can be folded or rolled for shipping. There is a possibility to cut the strip between any two glass tiles during deployment or during deployment preparation and install a connector there, to connect both electrically and mechanically, as depicted in FIGS. 8H and 8I.

FIG. 9D demonstrates how a strip of continuous sealed PV module can be cut between any two PV cells (102), as long as they are covered with 2 different glass tiles (224) to create a continuous PV cell strip according to the required length of the PV cell strip (258). The conducting tab (114), the sealing silicon (225), the EVA (154) and the back sheet (226) (all described in FIG. 9A), can all be easily cut with a dedicated Guillotine or a special knife or laser or any other tool without hurting the PV cells.

Such cut can also be implemented at a thin film laminated strip between any two thin film cells (285) as demonstrated in FIG. 9E. Thin film conducting lines (282) collect the current from the thin film cell (285) which is connected in series through a conductor (283) to the next cell. The cell edges are marked as (284). The cut (225) can be implemented at that conductor (283), and after scrubbing the sealing layer there a connector can be installed.

After the cut as in FIG. 9D, a flat connector (227) can be installed on the edges of the PV cells strip where it was cut, an example for which is detailed in FIG. 9F: the back sheet (226) of the strip of the PV cells that covers the conducting tab (114) is scrubbed, maybe by a dedicated scrubber, at the soldering points (232) so the soldering points are exposed and soldering can be executed. The soldering is conducted with a dedicated soldering iron or laser or any other tool, after which the connector box (233) is glued and sealed with silicon or similar material to the strip of the PV cells (102). The connector box has also a top cover (234) and a connecting tab (235) with connecting pipes (236) where the connecting wire can be plugged in (see FIG. 9G) and a by-pass diode (108).

Such ability to cut and attach a connector to the edge of a sealed PV module or a continuous profile module or a PV cell strip can be done in many other ways, one of which is using penetrating screw to penetrate the isolation layer and electrically connect to the conductor underneath.

FIG. 9G shows how two flat connectors (227) connect two continuous profile modules (243) where needed. The connecting cable (135) has two mail connectors (161) that are inserted to two female connectors (162) in the flat connectors (227). Later in this document, FIG. 21A will illustrate how such flat connector connects two parallel continuous profile modules at the edge of a roof.

This ability to manufacture un-limited length of PV cell strip with enough flexibility for efficient shipping (e.g. after rolling it), cut it according to the roof length and install connector there enables the flat profile to cover any roof size with one strip from one side of the roof to another with no connectors in the middle and is also considered important embodiment of this invention.

It is also possible to manufacture the PV cell strip in the required length in the 1st place after measuring the required deployment surface, but this requires custom manufacturing for each specific project.

In order to better protect the edges of the sealed PV module, it is also possible to wrap the continuous capsulation sandwich around its lengthened sides with a sealing and/or protecting layers as demonstrated in FIG. 9H.

FIG. 9H shows a continuous capsulation sandwich with glass tiles whereas some of its layers are wrapped around the edges prior to the lamination in order to better protect the edges. The PV cell (102) can be wrapped by EVA (154) that can be folded around the edges (269) or placed as two separate layers, whereas the ETFE protecting layer (270) is wrapped around the EVA (154) and folded around the edges (269). The glass tiles (224) can be attached on the top by using another EVA layer and a back sheet like PET (228) can seal from the back. This can also be manufactured without glass tiles (224) and its supportive EVA layer, but then the ETFE layer (270) needs to be thicker for mechanical protection. The tub (114) is included in the capsulation. Any protecting material can be used instead of ETFE and at least one side of the PV cell needs to be protected by this-the side facing up when deployed on the deployment surface. Any gluing material can be used instead of EVA. A lamination process can be conducted to glue all the layers together. This type of continuous capsulation sandwich can incorporate also perovskite layer or similar material that will be spread on the ETFE protecting layer to add more power, which can be connected to a separate electrical circuit.

FIG. 9I demonstrates another type of lamination machine, a weight-based lamination machine, that provides longer pressing time and a method to manufacture the folding solution to protect the edges of the product (whether it is the sealed PV module or the PV cell strip) for the lamination sandwich described in FIG. 9H. The PV cells (102) are moving on a conveyor (271) from right to left. The soldering iron (237) is soldering the PV cells (102) to each other with the conducting tabs (114). 3 EVA rolls are feeding EVA sheets (154), or any other continuous sheet of capsulation material in between the glass tiles (224) which are connected by silicon (225) and the ETFE protecting layer (270), in between the ETFE protecting layer (270) and the PV cells (102), and finally in between the PV cells (102) and the back sheet (226). The ETFE protecting layer (270) is folded around the edge of the PV cells (269) by two folding rolls (276). In order to best maintain the vacuum in the lamination chamber (274), the entire lamination sandwich is first moving through the transition chamber (272) on the right, in which vacuum Is created by a vacuum pump (273) after the flexible doors of the transition chamber (272) are in a sealing position. Once the proper vacuum is reached, the entire lamination sandwich is moving further into the lamination chamber (274) while the bottom of the door on the right of the transition chamber (272) is moving with the lamination sandwich, maintaining the sealing. After this step is finished, the bottom of the left door of the transition chamber (272) is moved to the right near the right door of the transition chamber (272) and sealing the transition chamber (272) again from the lamination chamber (274). Then the bottom of the right door of the transition chamber (272) is also moved right at a similar distance as the left door moved, while giving up on the sealing of the transition chamber (272) which is now filing with air (this air doesn't penetrate the lamination chamber (274) since the left door of the transition chamber (272) is in a sealing position. Then the entire process occurs again. Whenever a full PV cell (102) is entering the lamination chamber (274) a heavy weight (275) is placed on it by the weight arm (279), or it is otherwise pressed. Then the hot conveyor (277) is heating the lamination sandwich to a temperature in which the EVA is melted, and then the cold conveyor (278) is cooling down the lamination sandwich to ensure proper glue of the layers before leaving the lamination chamber (274) through another transition chamber (272) on the left with similar process as it entered. Before a PV cell exits the lamination chamber (274), the weight arm (279) is lifting the heavy weight (275) and placing it on the new PV cell (102) which just entered the lamination chamber (274) from the other side. Another vacuum pump is also maintaining the vacuum of the lamination chamber (274). The system can use also capsulation material that doesn't require heating and the curing is done by other methods, such as radiation (e.g. UV). It is also possible to do this process without vacuum, if the heavy weight (275) are heavy enough.

FIG. 9J shows a zoom in of the folding rolls (276), which fold the ETFE protecting layer (270) around the PV cells (102) and its EVA layer (154). Such folded layer can be also implemented with different materials and in different methods, for example with a narrow strip only around the edges or with robotic arm that does the folding.

Similar folding solution can be also implemented in regular PV panels, reducing the waisted edge area of the PV panels.

The lamination machine described in FIG. 9I can include several strings of lamination sandwiches entering into a single lamination chamber and instead of a weight per each PV cell there can be one large plate pressing on many PV cells in several strings at once.

Many types of lamination machines can be used, and the above are only a few examples. For example, there are several options to combine roll lamination and heavy weight in the same machine.

The limitless length of the continuous profile module allows the entire system on any roof slope to be fixed into the best angle from one control point so that no absorption surface is wasted on strengthening the profile or on connectors (either mechanical or electrical). The rigid structure that provide the strength of this continuous profile module enables setting it on any slope level and it will still work well, from flat parallel to the ground, up to vertical on walls, and it can endure strong winds and extreme weather conditions in all those angles and slopes, especially when covered with small glass tiles, which are much more durable than large glasses covering PV panels, for example during strong hail.

The ability to cut the string of PV cells and mount a connector there enables creating any length of PV cell strip with one PV cell resolution, thus creating a carpet of PV cells that covers the entire roof, no matter what its shape is, while keeping un-covered spaces at the edges to less or equal to the size of one PV cell. Such carpet of PV cells can be rolled for shipping and unrolled as detailed later in FIG. 27, and unlike other solutions in the market, such as PV sheets, can keep the high efficiency of silicon PV cells and doesn't require many connectors like with solutions like PV tiles.

A solution of continuous profile module as described here has several more advantages: it can support such PV cell strip solution but it can also support PV sheets solutions and set them in the best angle to face the sun for different roof slopes and orientations. In the flipping (or rotating) version of the solution, the entire array of profiles can be adjusted to a similar direction from one central control point, which can be controlled manually or by an engine and a computer. As described, the continuous profile modules can be mechanically connected to be set together at a similar angle.

In the fixed version of the solution the adjustments can be made during the manufacturing stage, or the assembly stage off site, based on pre-mapping of the slopes' level and orientation of the covered roofs.

With such a continuous profile module any size of PV module can be built with any number of PV cell, much larger number than any PV panel.

Based on electrically connecting the continuous profile modules to each other at the edges of the deployment surface, a continuous connection in series can be achieved, and can reach any voltage required without complex wirings between PV panels (even 900 V and more). All the PV cells on the array of continuous profile modules are facing similar direction (or directions in the case of V-shape profile) and are experiencing similar level of self-shading, which is a significant advantage as will be explained later.

In order to increase the cooling efficiency, the positioning system can include a cooling system in which water can flow through and farther cool the PV surface, as detailed in FIG. 10. The system can also hold water flowing above the PV surfaces, thus cooling them much more and achieve a total of 7-14% increase in power generation efficiency due to cooling, as also detailed in FIG. 10. Unlike systems using sprinklers or other methods to cool the PV surface with water flowing on top of it, in this solution water can be in a closed loop system without losing some of the cooling liquid due to evaporation or splashes thus minimizing loss of the cooling liquid, and optical coupling can be maintained between the cover, the water and the PV surface. Alternatively, the cooling material or the cooling fluid can be a different transparent liquid instead of water, or a transparent cooling gas, such as air or any mix or combination of them.

FIG. 10 shows a cross section of a V-shape profile with a cooling system. Cooling water coming from external reservoir enter the cooling water radiator (126) in the positioning system (120) through the entrance pipe (140) via a local cool water exchange hole (142). The hot water that absorbed the heat from the sealed PV module (156) go back to the external reservoir through the exit pipe (141) via a local hot water exchange hole (143). In order to better cool the sealed PV module, water can also flow through the internal V space (153) while cooling the PV surface without blocking the radiation coming from the sun, since they are transparent. This FIG. 10 also shows how the water flow can support a cleaning mechanism of the top cover (119) by using a local connection that is deployed periodically on the V-shape profile: when the water pressure is increased, a valve piston (180) opens, and water flows through the water tube (179) and are forced out through the water splash hole (182). Once the pressure is reduced back to normal, a spring (181) sets the valve piston back to a sealing position. The hot water generated by the system can be used for commercial or residential purposes, including heating. It is important to note that having a pipe mounted in parallel to the V-shape profile from which the liquid or gas are injected, enables cooling the whole profile at the same level, since each unit in the profile is getting fresh water or gas from the reservoir through the parallel pipe at the same temperature, and not water or gas that already got heated by cooling other units.

In the deployment process, the sealed PV module strip is inserted into the positioning system and is mounted inside it in a V-shape. The V-shape can be replaced by a round shape, or a combination of round and V-shapes, or any other shape that can expose PV cells or PV surface in better absorbing angle to the sun light beam.

In the case of the V-shape, the V angle (128) between the two PV surfaces of the sealed PV module can be anything between 1 degree to 179 degrees, but best performance per square meter is received usually when this angle is between 50 to 130 degrees.

The 2 PV cells creating the V-shape can be produced from one PV surface which is flexible enough to create the V-shape, or U shape or any similar shape. This V-shape profile can be mounted on a base, as detailed in FIG. 11, which can be also manufactured in extrusion method, or any other similar base. One of the base's functions is to position the V-shape profiles in parallel (geometrically) at a a similar distance between them and at a similar orientation, for reasons that will be detailed later.

FIG. 11 shows a cross section view of how an array of V-shape profiles is mounted on the base of the system (160) in a way that enables it to change direction in different settings by using the shifting flat rod (158). The base has a rotating axis cradle (157) containing the rotating axis (123), at least one angle setting axis chassis (159) containing the angle setting axis (124) and connectors between the base units: the male (161) and the female (162). This enables to set the V-shape profiles as much as possible towards the absorption direction (136) or any other preferred/desired/selected direction, by placing the setting tooth (191) of the shifting flat rod (158) in one of the setting holes in the base (192) which is a special base unit with angle setting mechanism (228). Once the setting process of mechanically setting the direction is done, the V-shape profile is mechanically locked at a fixed angle and fixed direction relative to the absorption direction in a way that doesn't enable them to tilt more than 10 degrees to either side without breaking, so weather forces like wind and hail will not move it from the desired direction, and it can be designed to be strong enough so even men made forces (like walking on the continuous profile module) will not change the set angle. Such setting means can be applied also for any continuous profile module, including flat profile, and also for any rigid element with PV surface, not necessarily for a continuous profile module. The locking means can be of any type. The set angle, (sometimes called the fixed angle), can be any angle: from PV cells that are positioned parallel to the roof slope and up to almost 180 degrees upside down, while both extreme angles are not effective, except when the PV cells are parallel to a roof slopes in the specific rare case that the roof slope is facing exactly the direction of the absorption direction. As a reminder, absorption direction (136) is the best static direction to absorb the sun radiation on aggregate throughout a whole year by minimizing reflection as well as maximizing the flux of the photons colliding with the PV surface.

The V-shape profiles can be tilted in different angles relative to the base, to maximize deployment' efficiency on different parts of the roof that have different slopes in different directions, as detailed in FIG. 12, and overcoming the orientation limitation of PV sheets and flat PV panels, as described in the background.

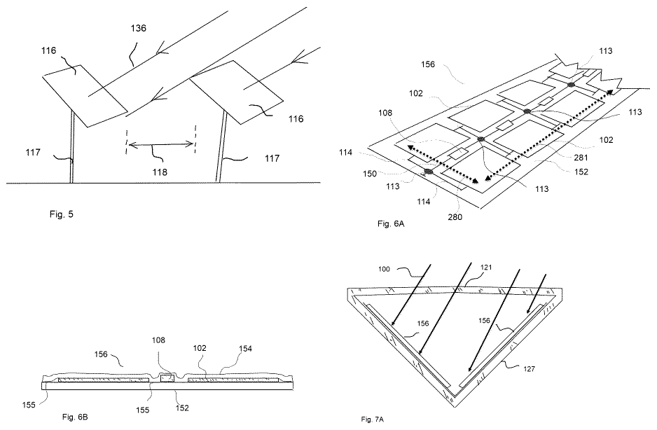

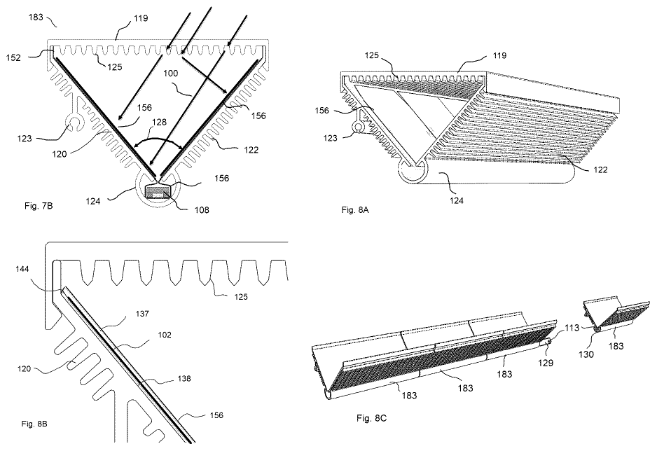

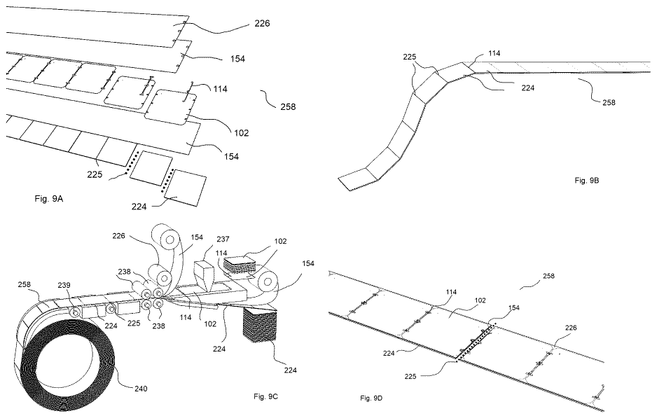

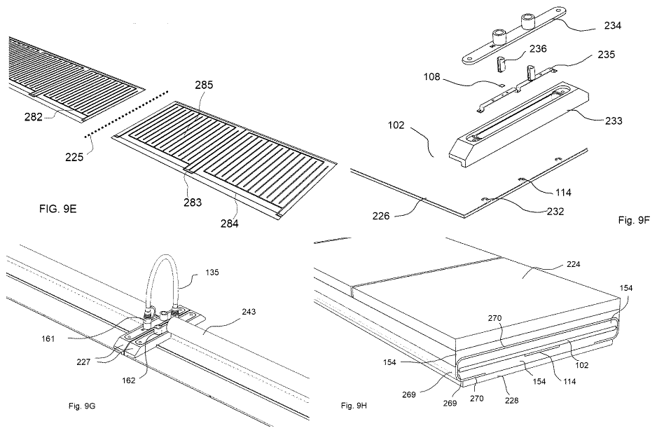

FIG. 12 shows a cross section of the same system as FIG. 11, but it is set to a different angle to accommodate different absorption direction (136) relative to the roof. All the positioning systems are connected to a shifting flat rod (158) at the angle setting axis chassis (159), which contains the angle setting axis (124). Moving the shifting flat rod left or right (as the arrow (198) shows), would rotate all the positioning systems together to a similar angle. This could be a one-time set up when the system is deployed, to accommodate different roof slopes and directions, or a dynamic tracking mechanism to change the elevation angle to which the V-shape profile is facing, so that it would follow the seasonal changes of the short-term absorption direction throughout the year, if the system is deployed with an angle movement which is north to south. Short-term absorption direction means the same definition as the regular absorption direction, but for shorter time frame than a year. This can be per day, week, month, season or any other time frame. The shifting flat rod can also be connected (266) to an engine (173), controlled through an electrical wire connection (265) by a computing unit (174), to control these elevation angle changes automatically. Another option is to deploy the system in an east to west angle movement, in which case the system can automatically track the sun movement during the day. The term accommodate as used herein means also best fit or compensate as the case may be FIG. 13 shows how the system accommodates different roof directions and slopes, by setting the direction of the V-shape profile (183) toward the absorption direction (136). In this Fig. the absorption direction (136) is in the south, so the southern part of the roof is simple to adjust. On the other hand, the V-shape profile (183) on the north side of the roof is adjusted upwards and towards south to the possible extent. This FIG. 13 also demonstrates how the whole roof can be covered with effectively tilted PV cells, avoiding large un-filled areas on the roof as depicted in FIG. 2, and not compromising on low absorption efficiency of PV sheets that follow the slopes and directions of the roof, as well as PV panels, as depicted in FIG. 3.

FIG. 14 shows an example of possible settings of the V-shape profiles on a northern roof with a steep slope in the northern hemisphere, when the absorption direction (136) comes from the south.

The continuous structure of the solution enables cutting the V-shape profile strip at any required length, covering also the edges of a roof which may not be square, as demonstrated in FIG. 13, and enables covering that entire roof, unlike the large PV panels, as depicted in FIG. 2.

An important embodiment of this invention are the solutions to overcome the shading effect, including self-shading, for continuous profile modules, 3-dimension structures like the V-shape profile, flat profiles and for PV panels where applicable.

In the first solution to the shading effect, as mentioned above, the positioning system may have a top cover that also includes an array of optical elements (125) that defuse or scatter the collimated sun light beam (100) to different parts of the PV surfaces, as depicted in several Figs., such as FIG. 7B.

(The sun radiation arriving to Earth does have a small angle variance (~0.5%) so it's not fully collimated, but for the sake of this document collimated is a good enough description). The optical element spreads the light beam so that it collides with the PV surface from different angles (i.e. from different directions) thus overcoming any local shading due to the sun direction relative to the direction of the V-shape profile (see example in FIG. 15A).

FIG. 15A shows a cross section of an array of optical elements in the top cover (119), each optical element (125) is splitting the sun light beam (100) at each relevant splitting point (167), part of it is reflected and colliding with the left PV cell (165) and the other part is passing through the optical element, maintaining a similar direction or a slightly diverted direction (166) (depending on the colliding angle and the ratio of the refractive index between the materials), and colliding with the PV cell on the right. Many points on the PV cell receives photons from several directions (164), that enter from different optical elements, ensuring that things that block the radiation at sporadic points on the cover, like dirt stains, will not cast shadow on the PV cells.

Diffusing the light in such a system results in many photons colliding with the PV surface at a distance from each other larger than their original distance when reaching the optical elements (unlike concentrating objects which are the other way around).

The optical elements can be set to diffuse equally to all directions as depicted in FIG. 17, or with preference to the near-by PV surface, as demonstrated in FIG. 16. They can also be designed differently according to their distance from the center of the V-shape profile, to accommodate for the different diffusing angles which are desired.

FIG. 15B shows a 3-dimensional drawing of the lengthened optical elements (125) on the internal side of the top cover (119). These optical elements are set in parallel to the strip of the sealed PV module, so they diffuse photons perpendicular to the long axis of the continuous profile module, prioritizing the near-by PV cells. (since their cross section is the same along the lengthened dimension, the sun light beam (100) is only diverting orthogonal to that axis).

FIG. 16 shows a cross section of another type of cover with raised walls (175) to increase the distance between the cover and the PV cells. Therefore, the diffusing effect is more effective, since the spreading distance of the diffused light before colliding with the PV surface is longer. These walls can be part of the transparent top cover (119) so some of the diffused light will reach PV surfaces of near-by V-shape profiles, or it can be part of the positioning system or it can be a separate article. If it is non-transparent, the walls can be designed to act as mirrors and reflect the light back (178) to the PV cell (102). It can also act as a beam splitter, reflecting part of the light only. This example also demonstrates how concentrating lenses (177) can be used as a diffusing element, by picking concentrating lenses which their focal point (147) is much closer to the cover than to the PV cells, thus the light beam after the lens (168) is spread and it acts as a diffusing element at the point where the radiation reaches the PV surface.

FIG. 17 shows the round (symmetrical) optical elements (169) on the internal side of the top cover (119) from a different angle.

The top cover in FIG. 18A can also reduce the reflection of the sun radiation when the sun is at a low angle by having an anti-reflection structure.

FIG. 18A shows the top cover of the positioning system (119) which includes both texture objects that reduce reflection (170) on the upper side as well as round optical elements (169) that diffuse the light inside the positioning system. The textured surface can help with the diffusion as well, especially in combination with the diffusing elements.

By diffusing or scattering part of the sun radiation that could light up one PV cell to the direction of other PV cells, the system can eliminate the challenge of shadowed PV cell due to local shadow, such as a dirt stain on the cover. Such diffusing or scattering object can help also regular PV surfaces (without 3-dimension structure) to overcome local shading effects, as long as the optical element is positioned high enough above the PV surface, as shown in FIG. 18B.

FIG. 18B shows a close-up cross section of a PV panel with optical elements (125), that demonstrates how the sun light beam (100) arriving at the optical elements (125) above one of the PV cells (102) can light up another PV cell nearby and eliminate the shading effect caused by any randomly occurring shadow on the nearby PV cell. This demonstrates the potential contribution of such optical elements to a regular PV panel as well. The definition of “high enough” means a height in which a single optical element diverts a portion of the photons of a collimated beam so that they collide with the PV surface at a distance of at least 3 millimeters between the photons.

The second solution that overcomes the shading effect is an adequate design of the continuous profile module. The continuous profile module can be adjusted to accommodate the slope steepness and orientation of the deployment surface (e.g. roof) in relation to the sun (FIGS. 11 and 12) in a way such that no shadow will be cast in all important sun angles. In the case of a rotating solution like the V-shape profile, the adjustment is enabled by the inherent tilting capability of the V-shape profile around the rotation axis and the capability to set the system at the desired angle enable this solution.

The third solution to overcome the shading effect is tracking. As demonstrated above, the continuous profile modules can have a rotation axis that can be connected to an engine, controlled by a computing unit, that rotates them on one axis, (e.g. moving from East/West). This allows the system to follow the sun direction throughout the day, leading to a significant increase in absorption efficiency, as it optimizes absorption in all sun angles. On a flat roof, an array of such rotating units can be arranged in a panel structure that in addition to tracking the sun movements horizontally, can be set at a different tilting angle according to vertical changes to accommodate the short-term absorption direction.

This would allow to adjust to the best tilting angle in different seasons/months/days of the year, either manually or by using an engine. It is also possible to set the profiles' tracking axis to track only vertical changes in the short-terms absorption direction, while the V-shape profile is set from east to west, thus shading is avoided, as depicted in FIG. 19A. The tilting adjustment can be done manually or automatically, in a frequency of every day or once a week, or less, and even only twice a year to accommodate changes in the short-term absorption direction during winter vs. summer only. The tracking algorithm can be based on a pre-programed direction plan based on day of the year/time of day settings, or dynamic adjusted tracking that searches in real time for the best angle to generate the highest electrical power possible at that moment or any combination of them.

FIG. 19A shows how the system can be deployed such that it tracks the changes of the short-term absorption direction (222) by setting the system so the rotating axis (123) rotates vertically, without horizontal tracking of the sun.

Such vertical tracking can also be used for a daily tracking of the sun height changes during the day, which might be more efficient than horizontal tracking on a flat roof, if the system is deployed far enough from the equator.

The fourth solution to the shading effect is to connect an electrical bypass means, such as bypass diode, in parallel to a PV cell or a group of PV cells to be activated when those PV cells block or significantly reduce the power. An example of this solution is detailed in FIG. 6A. This solution is challenging to deploy separately for each PV cell in regular PV panels because it will require a different and more expensive design, as well as additional assembly process. Therefore, there are usually only a few diodes in each regular PV panel, each one usually can bypass two rows of PV cells. Roll up PV sheets are also challenged with adding diodes in high resolution. However, in a system and method like the one detailed here, it is easy to add a diode to each PV cell or each couple of PV cells as shown in FIG. 6A, in a way that it doesn't waste PV surface area. Since a diode can be set separately for each PV cell too, the sealed PV module can be manufactured separately for each side of the V-shape profile. One of the options is to deploy a diode for each PV cell which contains only the silicon part of the diode (i.e. silicon DIE) so its width is similar to the width of the PV cell, which makes it easier to capsulate and to achieve good optical coupling with less coupling material, such as silicon. FIG. 20 shows a way to connect a DIE bypass diode per each PV cell as part of a strip of PV cells.

FIG. 19B shows in an exploded view how a DIE diode (261) can be connected between a bypass conductor (260) and the conducting tab (114) in order to electrically bypass a faulty PV cell (102) without exceeding the width of the PV cell

The fifth solution to the shading effect under self-shading includes designing the system to spread the shadow evenly between all PV cells as in the continuous profile module. Another way to look at it is that the system spreads the light evenly on all PV cells. The shadow doesn't have to be at the same shape on each PV cell, but the PV modules should be arranged such that the amount of solar illumination is similar on each vertical group (or column) of PV cells during self-shading conditions in order to avoid an electric bottleneck, This way, any self-shading cast by the system, will reduce the power generated by the system proportionally with the percentage of shading, at a similar level for all the vertical groups (or columns) of PV cells, without creating the shading effect. Because all vertical groups in the array of the continuous profile modules experience the same shadow there is no bottleneck created by one (or a few) shadowed PV cell, and none of them is blocking or shrinking the power generation of the series as in the shading effect. Since all continuous profile modules are mounted in parallel to each other with the same orientation and the same gap between them, the shadow cast by one continuous profile module on another is similar for all continuous profile modules (as depicted in FIGS. 20B and 21A). Only the energy of the excessive photons that collide with the first continuous profile module facing the sun (in case of a flat profile for example) and with the edges of the continuous profile modules may be lost. (excessive since the PV cells there will get more photons than the majority of the PV cells in the array and since all the PV cells are connected in series (i.e each PV cell is connected in series to the next PV cell), the current will be set according to the PV cell receiving the smallest number of photons and the energy of these extra photons will be lost). So except for these lost photons defined in the previous paragraph, the performance of all the PV cells of the array of the continuous profile modules are reduced at similar level, without creating bottlenecks. First row that is facing the sun means the first continuous profile module in an array, which on FIG. 21A is the one on the right side of the array.

Since the shading effect is resolved this way in spite of the self-shading, the continuous profile modules can be set close to each other with no gaps between them, filling the entire deployment surface. This means that all the photons arriving to the deployment surface collide with PV cells in all sun directions, and the only photons that be wasted in such a solution in times of self-shading are those lost photons defined above.

This solution for self-shading works well when the vertical cross section of the continuous profile module is comprised of a single PV cell, as well as when a couple of PV cells are connected in parallel at every vertical cross section of the profile, like in the V-shape profile. Vertical cross section as used in here for continuous profile module means vertical to the row of PV cells, which means vertical to the lengthen dimension of the continuous profile module. However, the same electric connection design can work well with this solution for self-shading, also when there are multiple PV cells at every vertical cross section of the continuous profile module, as long as they are connected in parallel to each other, and the vertical group (or column) of PV cells is connected to the next vertical group (or column) of PV cells in series. For example, the V-shape profile can be comprised of 4 PV cells in parallel (2 on each side) or 6 or any other number of PV cells that makes sense mechanically and electronically. Any dimensions of PV cells are fine, as long as the shape doesn't create none linear bottlenecks when partially shaded. Any type of PV cell technology is fine, as long as its material doesn't create a none linear bottleneck when partially shadowed. If the current generated by each continuous profile module is lower than required, there is an option to connect few of them in parallel, like in the case of the V-shape profile.

FIG. 20A shows a cross section of how the sun light beam (100) can collide with the surface of the sealed PV module (156) over the entire left side of the V profile, while the right side has a shadow cast on part of it (171). All the flat profiles mounted in parallel experience the same self-shading level on their right side, thus connecting electronically all the PV cells in a vertical cross section of the continuous profile module in parallel, and connecting all the cross sections of the continuous profile module in a series, would reduce the power generated by all those PV cells at the same level, ensuring none of them becomes a bottleneck for the power generation. FIG. 20B shows a 3-dimensional drawing of FIG. 20A.

The functionality of eliminating the shading effect with a continuous profile module can be achieved with regular flat PV surface (not 3-dimensional), which is based on the PV cell strip that was described in FIG. 9A. An example of which is described in FIG. 20C.

FIG. 20C shows a bottom isometric view of a solution based on continuous profile module with a flat PV surface instead of the V-shape. The base units (190) is attached to the roof and is holding the leg units (245) in which a quick connection unit (246) is plugged in and the flat profiles (229) are inserted to it. The flat profiles are comprised of rotation axle unit (243) and a sealed PV module (156), which are connected as depicted in FIG. 21B. The quick connection unit (246) is connected by a tilting axis (247) to a tilting arm (248) which is connected to the tilting rod (255). The tilting rod (225) is moving within the leg units (245) and the base units (190) back and forth in order to tilt the flat profiles (229). This is done by tilting the tilting arm (248) that tilts the quick connection unit (246) that tilts the flat profile (229). The electric wire (135) with its two mail connectors (161) is connecting two flat connectors (227) in two adjacent flat profiles (229) in order to create the series connection. The sealed PV module (156) can be covered with ETFE or with glass tiles for protection as depicted in FIG. 9A. In order to maintain the self-shading solution valid, the tilting arms (248) should have the same distance between them for all of them when connected to the titling rod (255), but this distance can change based on the roof slope direction and steepness, the location altitude and other parameters, in order to set the system in the most cost-effective way in terms of cost per watt. The distance between the leg units (245) connected to the base units (190) should also be the same for all leg units. This flat profile solution also demonstrates a design for an easy way to replace faulty module of the flat profile by pulling out the electrical connectors (161), removing the flat profile (243) from the quick connection units (246) then inserting a replacement flat profile (229) instead and plugging it with the connectors (161). The view of the base unit (190) that is closer to us in FIG. 20C details the system's components inside the base (190) and inside the leg units (245), as well as how they connect.

Since here too all the PV surfaces are mounted on the continuous profile modules which are mounted in parallel, and the continuous profile modules have the same rotation angle and the same gap between them, partial shading of one continuous profile module on the next one does not create the shading effect, as depicted in FIG. 21A.

FIG. 21A shows an array of flat profiles where all the sealed PV module surfaces (156) has similar level of shading (171) at any angle of the sun light beam (100), thus there are no bottlenecks for the power generation. This Fig. also demonstrates how such a flat profile can cover roof slopes that are not facing the absorption direction (136). This type of solution, like the V-shape profile, can be static, but it can also track the sun throughout the day. The tracking algorithm can aim the PV surface to face the sun, or to face sidewise from the sun, if the absorption is better in a different angle. With some PV cells it is better to face 3 degrees away from facing the direction of the sun in order to increase absorption efficiency. In other cases, 10 degrees work better, and even 20 degrees may work better for generating power depending on the type of PV cell that is used. Most likely, the reason for this is that photons that enter the PV surface in an obtuse angle, travel a longer path within the PV cell, which means they have higher chance of being absorbed by the PV cell and generate electrical power, and this compensates for the reduction in photon flux for those angles.

When the sun is in very obtuse angle, setting the profiles perpendicular to the sun, which is theoretically the best angle, creates very large shadow and very narrow strips of light on the PV cells. In such a scenario, the self-shading solution is very sensitive to tolerances in the system. For example, if the light strips are only 5-millimeter-wide, and one of the light strips is only 4-millimeters-wide due to system tolerances, the power will drop by 20% for the entire array. Thus, smart tracking will increase the light strip as much as possible before the threshold where reflection increases, so the light strips will be as wide as possible and such tolerances will have minor effect. This can be done based on optimizing power measurements in real time or by using a pre-set plan according to the sun direction relative to the roof at any given time, or any combination of them.

This flat tracking solution can rotate more than 90 degrees, up to 160 degrees and even 180 degrees to enable best daily tracking of the sun.

Different roof slopes will cause different levels of self-shadow cast on the continuous profile modules so some type of inverter needs to adjust the voltage and amperage of each array of the solutions described here separately on each slope. In some cases, different gaps between the continuous profile modules on different roof slopes can be set in order to get the same level of shading on the different roof slopes by adjusting the distance between them.

Another problem that may occur with such long continuous profile module is that when temperature change, there will be a different lengthening of the sealed PV module relative to the part on which it is mounted, a problem that can break the continuous profile module or bend it. FIG. 21B shows an example solution for such a problem.

FIG. 21B shows more details of the flat profile: the sealed PV module (156) here includes a strengthening back sheet (241) that has the same lengthening reaction to heat like the sealed PV module, and it is attached to two L profiles that together create a rail (244). The lengthened rotation axle unit (243) is inserted into the rail (244), so it can move freely on the long axis of the continuous profile module. This way when the sealed PV module and the rotation axle unit (243) are lengthening differently when temperature changes, the continuous profile module can accommodate for it without bending or breaking. In order to seal and protect the edge (256) of the sealed PV module (156), the back sheet (241) can be transparent and wrap the edge (256), or a dedicated protection material can be implemented, or some type of welding can be done between the back sheet (241) and the front cover of the sealed PV module, that can include glass tiles, ETFE or any other relevant material.

The flat profile has another advantage for hot countries—it covers the entire roof with a floating shading blanket that blocks the sun rays and enables air to move freely between the roof and the profiles, thus creating a cooling effect and reducing the temperatures of the covered house significantly. When referring to rows of PV cells in a continuous profile module, the meaning is a row PV cells which is parallel to the long dimension of the continuous profile module, while column means the vertical cross section of the continuous profile module, or perpendicular to the long dimension of the continuous profile module.

This solution of aligning all PV cells at a similar parallel orientation is not very effective for shading management when dealing with regular (flat) PV panels (107) as is. The reason is that all the rows of PV cells in a PV panel are connected in series, so one row of PV cells which is partially self-shadowed can reduce the power for the entire PV panel proportionally to the shadow size on that specific row of PV cells. As a result, the power generated by the entire PV panel is reduced proportionally to the shading percentage of a specific PV cell. When referring to rows of PV cells in a PV panel, the meaning is a row which is close to be parallel to the ground while column means close to be perpendicular to the ground. As explained, it reduces the power also for all other PV panels connected in series, even if they are fully exposed to the sun light without any shadow. In many cases a fully shadowed row does not reduce the power generation of the PV panel more than its surface area percentage out of surface area of the entire PV panel, because it is by-passed by its by-pass diode and not acting as a current bottleneck.

However, the same electrical connection design to eliminate the self-shading for a continuous profile module can be applied for PV panels as well. The vertical group of PV cells in each vertical column (i.e. those PV cells which are one on top of the other in each cross section, as depicted in FIG. 21C) are connected in parallel between them, and all the vertical groups within a PV panel are connected in a series connection between them. This electrical design solves the self-shading problem of PV panels, subject to mounting such PV panels in parallel mounted rows at the same distance between the rows of PV panels (i.e. in a way that each row of PV panels in the array of rows cast similar shadow on the row of PV panels behind it) and the same tilting angle, as depicted in FIG. 21C. Once the self-shading effect is resolved this way, the rows of PV panels can be set very close to each other, and they will function well in spite of the self-shading. This way a deployment of PV panels can achieve its maximum possible power generation per a given deployment surface throughout the entire year.

So, if all PV cells in each vertical group of PV cells within the PV panel (i.e. vertical cross section of the PV panel or column of PV cells) are connected in parallel, and all the vertical groups within a PV panel are connected in series, the partial shadow does not create any power bottleneck and the PV panels will function perfectly well under self-shading conditions. Thus, the shading of one PV panel on another PV panel has minimal effect, proportionally to the percentage of shadowed rows of PV cells (171) out of all rows of PV cells in the PV panel, and not disabling the entire PV panel. This solution enables deploying PV panels at the typical tilting angle (131) to accommodate the absorption direction (136), or any other preferred angle, without a gap between them (118), and to increase the power generated from a certain deployment are significantly.

FIG. 21C demonstrates an array of this new type of PV panel (163) (to be called new PV panel) with new internal wiring according to this invention, which enables the density of the rows of the new PV panels to be increased up to a point that there is no gap between them. Advantageously, no absorption surface is wasted during the whole day, except for those extra photons which collide with the first row of new PV panels in an area that is shadowed on the new PV panels (163) of the other rows (171). The vertical group of PV cells in each vertical cross section (151) (in the case of a new PV panel vertical cross section means all PV cells in a column) are connected in parallel, and all vertical groups in a new PV panel are connected in series between them. Because the new PV panels are mounted in parallel rows, the power generated by each new PV panel is similar to the other new PV panels under any self-shading conditions except for the lost photons (163), so none of the rows act as a bottleneck and does not reduce the overall power of the array of the new PV panels. In such a solution the bypass diodes may be connected per column of PV cells (i.e. cross section) and not per row of PV cells in order to electrically bypass a local lengthened shadow, such as the shadow of electric pole.

As a consequence of this invention for self-shading, the new PV panels can be also set with larger angle than the typical tilting angle (131), thus compacting the rows' arrangement of new PV panels even more then closing the current gap (118). This is true also for the solution described in 21D as well.

Similar solution as in 21C can be implemented for new PV panels which are tracking the sun, either in one axis or with full tracking, while eliminating all gaps between them.

FIG. 21D shows a deployment method in which regular PV panels (107) with some addition can also overcome the self-shading effect and only lose the power of one row of PV cells which is partially un-shadowed without impacting the other rows of PV cells in that PV panel. The Fig. demonstrates an array of PV panels (107) that their rows' density can be increased up to a point that there is no gap between them (118), so no absorption surface is wasted throughout the whole day, except for the lost photons as defined before (171). All rows of PV cells in these PV panels can have controller (FET or similar solution) (138) that initiate an electrical bypass and can also perform the bypass of a partially shadowed row of PV cells even when they are not fully shadowed, so they don't reduce the power generated by all other rows of PV cells in that PV panel and for all other PV panels. The fully shaded rows of PV cells are also electrically bypassed. A controller can be deployed per each row or each two rows of PV cells, or one controller can manage all the rows of PV cells in a PV panel, or any combination thereof. The switching algorithm to activate the electrical bypass of a row of PV cells can be by comparing its power to the row above and setting a predefined threshold of percentage reduction of power (e.g. factor) that activates the electrical bypass, or any other algorithm. The bypass can be canceled as soon as 80% of the full power from a specific row is regained, or any other algorithm. In this solution each row (or a few rows) of PV cells on the first row of PV panels (the row on the right) can have a bypass diode (108) to handle sporadic shading instead of a controller, since they don't experience self-shading. For this solution to work, the bypass solution and the controller must be deployed for at least one row of PV cells.

It is important to note here that diodes alone (without a controller to manage them) can't provide a proper solution since setting them to bypass a row of PV cells when there is a slight reduction in the power that the row is generating means that in obtuse sun angles, or when the sky is a little cloudy, the bypass can be activated for all rows of PV cells and no power will be generated. As an example, the bypass decision can be made locally, either with FET or with dedicated chip or with a few diodes that compare power of one row of PV cells to the next row and execute the bypass accordingly.

Similar solution can be implemented also at the PV cell level, so every PV cell with low performance will be electrically bypassed and will not reduce the current for the entire row of PV cells connected in series.

This type of electrical bypass means is also relevant for a continuous profile module solution, in order to optimize the power provided by a strip of PV cells connected in series, as depicted in FIG. 6B. Such a bypass FET solution can be implemented for continuous profile module at each PV cell, or for a group of PV cells of any number. In the case of bypass FET of a single PV cell in a continuous profile module, the local controller of each PV cell (e.g. FET) can be connected to the main controller of the row through strips on the flex PCB they are mounted on, and the row's controller can use any algorithm to decide which PV cell should be bypassed. As an example, such an algorithm can include the following steps:

Measure the current when all PV cells are connected. Bypass all PV cells in the row except for PV cell 1 and measure the new current. Do the same for every single PV cell. Sort the PV cells by level of current. Than calculate if the power of the entire row without the weakest PV cell is higher than the power of the entire row with the weakest PV cell and if so electrically bypass it and continue to the next weakest PV cell while doing the same calculation and so on for the rest of the PV cells. The process will end when the decision will be not to bypass a specific PV cell in that row.

The process can repeat itself every pre-defined time gap, such as every minute, every day, every week, etc.

Again—the by-pass decision can also be made locally by a dedicated chip or FET that compares the power of the near-by PV cells and decide if a by-pass should be executed. The FET can also execute the electrical bypass itself, without diodes.

Another option to overcome the self-shading effect for PV panels is to connect separately all the rows of PV cells that are shadowed in a series that will generate a small amount of power from in-direct radiation, and to connect the same way together those rows of PV cells which are not shadowed. Each of these series connection can be handled separately by a micro inverter or optimizer, so no sever bottleneck is created for any un-shadowed part of the PV panels. An example for such a solution will include 2 sets of power lines for every PV panel and a controller (e.g. FAT) that will monitor the power level for every row of PV cells in the PV panel and switch it to the high power lines or the low power lines based on its switching algorithm. Such switching algorithm can include as a decision factor a comparison of the power of each row of PV cells to the top row of PV cells in that PV panel, while using a predefined threshold of percentage reduction of power (i.e. factor) that will activate the switching decision, or any other algorithm. The algorithm can also be based on a pre-set plan that will by pass a row at a certain time of a day when it is partly shaded based on calculation of the sun location relative to the location and direction of the roof slope, or any combination of the two methods.

This ability to cast similar shadow on all the rows of PV panels mounted in parallel (except for the first one facing the sun) is subject to the nature of the deployment surface. This works well for a horizontally flat deployment surface of course, but also if it is tilted in any direction (any tilting from horizontal and vertical), and even if it is a bumpy surface like soil, or even a slope in the shape of stairs which are similar in size and shape. If the deployment surface is suitable, the self-shading will be similar for most of the PV panels on such a deployment surface, regardless in which gap, angle and orientation they are deployed, as long as it is the same for all the PV panels. This is also true for continuous profile modules. Such a suitable deployment surface is defined here as a deployment surface. Any type of surface can be converted to a deployment surface with proper infrastructure, as depicted in FIG. 21E.

One of the advantages of the continuous profile module is its durability for almost any deployment surface, since the base can be customized to accommodate any type of deployment surface by using proper infrastructure (see FIG. 21E), while the continuous profile module maintains all its unique qualities, such as the solution to the self-shading effect.

FIG. 21E shows on the left a 3-dimensional drawing of possible deployments of PV panels (107) on a curved surface (134) and a cross section on the right of a proper example deployment of PV panels (107) on a curved surface (134). When PV panels (107) deployed on a curved infrastructure that is attached to the surface (137), placing the PV panels at the same distance from each other as seen on the left side of the 3-dimensional picture will not generate the same self-shading for all of them as a result of the curved surface. Thus, this will not work to eliminate the shading effect. Such a situation can be solved by changing the spacing between the PV panels so that they will cast the same shadow size on the PV panels behind them (“behind” means relative to the absorption direction 136). An example of this can be seen on the right set of PV panels in the 3-dimensional picture, as well as in the cross section on the right picture: if the distance between each two PV panels (209) is adjusted to the curve and not fixed, then when the sun is in Zenit as in the sun light beam (100), all the PV panels have no shadow, and in other sun angles the self-shadow cast on PV panels (171) is the same for all the PV panels except for the first one facing the sun. Another option is to build a proper infrastructure (112), as seen on the right part of the 3-dimensional picture, the surface becomes competent as a deployment surface. Only few connection points between the deployment surface and the infrastructure (133) are required to install such infrastructure.

A possible method to deploy the PV panels in a proper adjusted distance (209) on a curved infrastructure (137) is to prepare the curved infrastructure (137) in advance in a way that PV panels (107) can be mounted at any point along the curved infrastructure (137). Then, during the deployment process to mount the first PV panel on the side of the curved surface which is facing the absorption direction (136) and then the next PV panel behind it (2nd PV panel) at a smallest distance in which there will be no shadow cast on the next PV panel during Zenit (this can be calculated in advance). Then the next PV panel (3rd PV panel) will be mounted at a distance in which the shadow cast on it will be similar to the shadow cast on the 2nd PV panel at the specific time of deployment. The rest of the PV panels will be mounted also at a distance in which the shadow on each of them will be similar to the shadow on the 2nd PV panel. This method can also work for continuous profile modules.

The 6th solution to the shading effect is to mount reflecting optical elements to divert part of the sun light beam (100) to a spot on the PV surface that wouldn't get light otherwise. Such optical elements can be partially transparent lances which are partially reflective or mirrors inside the V-shape profile (beam splitters), as detailed in FIG. 22A.

FIG. 22A shows how the Sun light beam (100) arriving from any direction, is trapped between 2 semitransparent lenses s (186) like this example of light beam (188), or is transferred to the next lens and be trapped there like another example of light beam (187). This solution enables all the sun light beams (100) to reach the PV surface, even in very obtuse angles of the sun, and therefore very little energy is lost due to reflection.

This point is a very significant one, because energy loss due to reflection from the glass cover in regular PV panels is very high, especially in obtuse sun angles, where the energy loss can exceed 50%. With this solution, the light collides with the PV surface in more orthogonal angles most of the time, so even if glass (189) is attached to the sealed PV module (156) or any other protective material, very little reflection occurs in all sun light beam angles. One challenge here will be the cleaning of the system, and this can be resolved by air pressure cleaning, or by using water that flows through the lenses, or by removing the module containing the lenses for cleaning and then placing it back or by any other solution. The spacers and holders of the lenses (186) are not seen in this Fig. since it is a side-view cross-section only. They can be seen in FIG. 22B which is a 3-dimensional drawing of a similar solution.

FIG. 22B shows a different type of small optical elements (193), partially transparent, that diverts the sun light beam (100) to the required part of the PV surface (156) which are connected by a spacer/holder (185) and covered by glass (189). The sun light beam (100) is partially reflected (188) from the optical element (193) and partially transfer through it (187).

To determine which parts of the 3-dimensional PV structure are not getting enough radiation under different sun light beam (100) angles and different positioning of the 3-dimensional structure, analysis of experiments and/or simulations can be used, resulting in optimized optical elements.

As another example, FIG. 22C shows a cross section of another type of semitransparent optical elements that divert and reflect the sun light beam (100) at different percentages to accommodate the relevant sun angles. The optical elements are comprised of partially transparent and partially reflective lengthened cubes. In this case, the optical system is designed to best handle a deployment where the V-shape profiles are set from east to west, so the sun light beam (100) always comes from the right, a scenario as shown in FIG. 19B. In order to maximize the light arriving to the top parts of the PV cells (102) in obtuse angles of the sun light beam (100) the cubes on the right (such as 125) are fully coated with reflection material (194) so a sun light beam (100) coming from the right and colliding with the cubes on the right is reflected back to the top PV cell on the right. On the other side, the cubes on the left side (such as 197) are not coated by any reflection material in order to enable the sun light beam (100) to go through them without interference as much as possible and collide with the top side of the left PV cell. The cubes in between them (such as 184) are gradually more reflective from left to right, to enable the best light spread on the PV cells. The cubes can have any type of surface shape such as convex or concave or any other shape or combination of shapes that can help spreading the light as even as possible to all parts of the PV cells (102).

Another option for an optical element that can spread the sun beam light (100) more evenly on the 3-dimensional PV structure, is comprised of an array of curved mirrors which are fully reflective, as depicted in FIG. 22D. In this FIG. 22D the curved mirrors (186) are spreading the sun light beam (100) across the sealed PV module (156) which is covered by glass (189), and any radiation reflected from the glass (115) on one side of the V-shape profile has a good chance to penetrate the glass on the other side of the V-shape profile.

This solution is very effective in minimizing the reflection from the glass and the EVA when the glass is not part of the cover but rather attached to the Sealed PV module inside the V-shape.

Both the glass and the EVA can be set with optical coupling between them and with the PV surface, thus further reducing reflection. There is an option also for direct coupling and sealing between the PV surface and the glass on one side (by using some optical glue or silicon between them), as well as sealing between the aluminum on the back and the PV surface (with some none conducting glue), so EVA or similar material will not be required. There is also an option to seal the PV cell with glass on both sides. One of the advantages in such a design is the ability of the PV cell to receive some photons from its back side and increase its power efficiency.

FIG. 22E shows a cross section of the software simulation results of such a solution as in 22D, while 186 is the curved lenses and 196 are the sun light rays that are lost due to reflection.

FIG. 22F demonstrates the simulation-based photon distribution across one of the PV cells in the V-shape profile as described in 22D, where the lighter lines mean more photons arriving there and the darker lines mean less photons.

As mentioned in the background, one of the major problems of PV panels is the high reflection ratio from the glass cover. Many anti-reflective coatings were developed during the years to overcome this problem, but their efficiency is limited as well as their durability. Thus, they typically wear out after a few years. In order to minimize the reflection problem, PV panels are lifted to a typical tilting angle (131) which positions them more perpendicular to the sun absorbing direction (136), using heavy and large infrastructure, as demonstrated in FIG. 2, and casting shadow on the nearby PV panels.

The seventh solution to the shading problem is to avoid the shading elevation in the first place, by attaching the PV panel or a continuous profile module parallel to the surface on which they are mounted, but still minimize reflection as if it was tilted towards the absorption direction (136) by incorporating elevation slopes (139) with the typical tilting angle (131) on the outer surface of the transparent cover itself, instead of positioning the whole PV panel in that typical tilting angle (131) as detailed in FIG. 22G. The elevation slopes are like lengthened stairs that are cut from the surface of the glass cover or any other transparent material used as a cover. This way, self-shading is prevented and the deployment surface can be fully covered by PV panels with no gaps between them (118). This PV panel can include 3-dimensional PV structure or two-dimensional (regular) flat PV surface.

FIG. 22G demonstrates a cross section of how a top cover (119) is manufactured with repeating elevation slopes (139) that accommodate the absorption direction (136) or any other preferred direction, thus minimizing reflection throughout the year. One of the main advantages of this invention is that the gap (118) that was demonstrated in FIG. 2 in order to avoid shading cast of one PV panel on another due to this elevated angle is no longer required when the elevation slopes are implemented in the glass and the whole PV panel is not tilted in that angle. Some of the photons that enter the slopes are reflected inside (146). In addition, since the cover and slopes are transparent, photons from the sun light beam (100) that cross a slope (148) can enter into the V-shape profile in the next slope (149) so it is not lost.

As mentioned above, the same solution of elevation slopes can be implemented also for flat (regular) PV panels. The sun light beam is colliding with the glass cover of the PV panel at the same angle as if they were tilted at the typical tilting angle, due to the slopes here while the PV panels are deployed actually flat on the deployment surface. So, there is no need to place the PV panels with a distance between them since there is no shadow cast by a PV panel on its neighboring PV panels, thus there is no loss of radiation due to space between the PV panels. This way the PV panels can be as close as possible while the whole deployment surface can be used and nearly no space is lost between the rows of the PV panels and no self-shadow is cast on PV cells. The slopes can be of any size as long as their width is at least one order of magnitude smaller than the cover of the PV panel.

The elevation slopes can be customized to accommodate different slopes and different directions of a deployment surface. If such a solution is used, it is also possible to manufacture all the positioning systems for a PV panel from one piece of aluminum sheet with a pressing method, as demonstrated in FIG. 22H.

FIG. 22H shows a set of positioning systems (120) that is manufactured by pressing one sheet of aluminum, creating the fixed shape of several positioning systems.

FIG. 23A shows a cross section of how a cover with elevated slopes (139) is mounted on a positioning system (120) that has an inherent angle built in to the V-shape profile to accommodate the absorption direction (136). There is also an option to cover the left side of the elevation slopes with mirroring coating to reflect more light to the right side of the V-shape profile.

An example for a flat PV panel with elevation slopes can be seen in FIG. 23B.

FIG. 23B shows an example for a flat PV panel (109) on infrastructure (137) with elevation slopes (139) that accommodate the absorption direction (136) or any other preferred direction, so any sun light beam (100) collide with the slopes at the same angle as if the whole PV panel was tilted to the absorption direction (136) or any other preferred direction. When the sun is in Zenit, the elevation slopes can deflect the sun light beam to a better colliding angle with the PV cells.

FIG. 23C shows a cross section zoom-in of FIG. 23B, where the PV cells (102) are inside the PV panel.

FIG. 23D shows a similar PV panel (109) on infrastructure (137) as in FIG. 23C on a roof slope that is facing the other way relative to the absorption direction (136) and the elevation slopes (139) are at an appropriate angle to accommodate it. The slopes can also be set diagonally in roofs that are not facing north or south, by using similar calculation as will be explained later for deploying diagonally continuous profile modules.

Elevation slopes can be implemented also on a tracking system, either on one axis or two axis tracking.

The elevation slopes described here are only one example of a lengthened shaped profile that is implemented to the glass cover of a PV panels, or on a cover from other transparent material. There are many other structures that have similar cross sections throughout one axis of the PV panel that can work well for this purpose.

These different solutions for the shading effect can be combined together to achieve maximum efficiency. For example, while the continuous profile module eliminates the self-shading problem, the diodes can handle sporadic shading.

In order to reduce the cost of the system, but with possible reduction in performance, one side of the V-shape profile can be replaced with a mirror that reflects the light over to the other side. This can be especially effective with the tracking version of the solution, since the optical system is aligned to the sun movement and the reflection is always at the same angle relative to the V-shape profile. One option of such a solution can be seen in

FIG. 24A shows a cross section of a V-shape profile whereas its right V wall is a mirror (104) instead of a PV cell. The sun light beam (100) which is reflected (115) from the mirror (104) is absorbed by the sealed PV module (156) on the left side. As the sun light beam (100) change its direction, the tracking system rotates accordingly the V-shape profile, so that the angles between the direction of the sun light beam (100), the mirror (104) and the sealed PV module (156) remains the same in-spite of the tracking movements and ensures effective absorption of the sun light beam (100) also after it is reflected from the first PV cell. This solution is called one-sided V-shape profile.

This option may also require a solution for the shading effect, as detailed earlier in the document.

According to some embodiments the V-shape profile is folded during shipping. The bending can occur between the different continuous profile modules, as detailed in

FIG. 24B shows how an array of connected V-shape profiles (183) can be folded together for shipping. The right V angle and tilting angle when deploying it will be set by the adaptors (249) that will fit into the base structure that can be set differently for each roof slope, in a way that will ensure the optimize deployment angles for that roof slope. In extreme case the V angle can be set near 180 degrees to create a PV carpet over the roof but with high efficiency of silicon PV cells that can be protected by glass and not thin film or PV sheets which has lower efficiency and less durability. Due to its flexibility, such a carpet can accommodate roof surfaces which are not flat (e.g. convex roofs surfaces).

If the V angle of the one-sided V-shape profile (i.e. with one side acting as a mirror instead of a PV cell and the other side covered with PV cell) is reduced below 40 degrees, the light that will enter the V from most angles will be trapped there and will not be reflected outside the V, so except for photons that turn into heat during the internal reflection, no photons are lost, as depicted in FIG. 24C.

FIG. 24C shows a cross section of a one-sided V-shape profile whereas its left side is a sealed PV module (156) and the right side is a mirror (104), with a V angle (128) of less than 40 degrees. The sun light beam (100) on the left representing summer sun (Zenit) and the sun light beam (100) on the right representing winter sun. As this Fig. demonstrates, the reflections (115) stay within the V-shape profile for both of them, so both of these sun light beam (100) from these angles and many other angles will be trapped in the V-shape profile and no photons will be reflected outside the V-shape profile. This is true also for any sun light beam that comes at an angle between the summer and the winter.

Other options according to some embodiments include other solutions for adjusting to different slopes and directions of roofs while maintaining similar angle relative to the absorption direction. Some of these solutions do not require any rotation, such as those where the solution positioning for each slope/direction of the roof is set during production by changing a parameter of one of the components of the system. An example for a solution that relays on trapping the light which was described in FIG. 24C is detailed here in FIG. 24D:

FIG. 24D describes a static V-shape profile structure which can be adjusted to different roof slopes relative to different absorption directions without a rotation capability, since it traps the light as depicted in FIG. 24C. Can be adjusted means capturing maximum possible photons (or almost maximum possible photons-up to 5% difference) at that location at that direction and gradient of the slope of the deployment surface. Instead of rotation, the parameter which is changing in order to adapt to different roof slopes, directions and latitudes is the height difference between the profiles when connecting them to one another. The unit example in this solution has a sealed PV module (156) on the left side and a mirror (104) on the right side. The combination of 2 units, that can be with a screw (257) creates the one-sided V profile, but also set the height of the connection to adapt to the slope of the tilted roof (223). Since the sun light beam (100) from many directions is trapped here (115), there is no need to change the angle of the sealed PV module (156) relative to the roof slope.

Such a solution has several advantages over the regular V-shape profile (i.e. the one with no mirrors). The mirrors of the one-sided V profile can be generated from polished aluminum as part of the continuous profile module and can also be used to strengthen the system and enable walking on it for maintenance purposes, without hurting the PV cells.

One of the disadvantages of the V-shape profile, especially in small V angles, is its tendency to trap dirt on the bottom of the V-shape. Possible solution for that is leaving lengthened holes at the bottom of the V-shape profile, so the dirt can slide out with the help of gravity, wind or rain. Another embodiment of this invention is splitting the V-shape profile into 2 parts and using only one side of it in a continuous profile module, as demonstrated in FIG. 24E.

FIG. 24E shows a cross section of a continuous profile module comprised of another flat profile to be called here the rigid profile. Each unit can be comprised of aluminum board or some type of plastic like polycarbonate (105) as a positioning system, that can also be transparent. PV cells (102) connected in a row, that can be deployed on flex PCB strip or a similar strip with a glass cover (189) covering it. These rigid profiles can be distant from each other as they were in the V-shape profile, with a V angle of 80 degrees for example, which means they have a significant overlap when they are flattened to horizontal position, creating a 3-dimensional structure. Any such distance is possible. The self-shadow (171) only reduces the power in proportion to its size on each PV cell (102) relative to the whole PV cell (102) size, i.e. for all the PV cells at the same level, so no photon's energy is wasted except for the lost photons as defined above. The rigid profile is mounted on a base (145) with a flat rod (144) that controls its movement. The glass cover can have unreflective structure such as coating or elevation slopes (139) and a bypass diode can be implemented per each PV cell or per a group of PV cells.

FIG. 25A shows a 3-dimensional drawing of a similar system as in FIG. 24E. It also demonstrates that if this system is tracking the sun horizontally throughout the day (i.e. rotating from east to west), and the angle between the sealed PV module (156) with the direction of the sun light beam (100) can be compromised, such system will not experience self-shading at all. Cooling elements (122) can be also implemented.

This rigid solution might not have the extra absorption due to the internal reflection between the two sides of the V-shape profile, but otherwise can have all the options/advantages mentioned earlier for the V-shape profile, including adjustment to any possible slops and directions of deployment surface, solutions for the shading effect, tracking capabilities, etc. One of the advantages of this embodiment is that this type of a continuous profile module doesn't require any external frame to hold it mechanically, such as the frames needed with existing PV panels. This solution doesn't require electrical connection that is connected through the frame, and especially not through a mechanical axis, as it is the case with some of the one-axis tracking panels.

For the sake of this document, the term electrical connection includes also electronic connection.

The rigid solution too, can incorporate all types of optical means to improve performance, such as the one detailed in FIG. 25B.

FIG. 25B shows a cross section of a static version of the rigid solution (i.e. no tracking and no direction setting after assembly) with mirrors (104) which reflect (115) the sun light beam (100) towards the PV surface (102) when the sun is high in the sky. One of the advantages of this solution is that the glass cover (189) is facing down and thus tends to accumulate less dust and dirt, resulting in lower cleaning maintenance needs.

The rigid solution can be set in any angle relative to the ground, from vertical (90 degrees relative to the ground or the horizon) and down to 0 degrees (parallel to the ground), as the case may be in different areas around the world. In most cases the angle will be smaller than 65 degrees from the ground or from the horizon (or larger than 25 degrees from vertical which is orthogonal to the ground).

The different angle of the PV cells relative to the roof slope enables much better energy absorption and much lower reflection then if the PV cells angle was similar to the roof slope. The fact that all PV cells are facing similar direction or similar two directions (like in the V-shape profile) or similar few directions enables to manage the shadow size cast on the profiles by other profiles, in a way energy is not wasted except for the lost photons as defined before. Roof slope can be defined as the slope of a strait flat rigid stick if it was laid on the roof from top to bottom.

FIG. 25C shows another example of a cross section of a static rigid profile (i.e. a rigid profile that can't be set in different angles) with minimum parts, whereas the new static base (190) is parallel to the deployment surface. The angle in which this rigid profile is set can be set during manufacturing according to the slopes of the deployment surface relative to the absorption direction. There is an option to connect the static base (190) with the rigid profile with flexible connection instead of rigid connection, so when hail is coming down it will absorb some of the impact and the rigid profile will not break. This can also enable walking on the rigid profile for maintenance without breaking it.

FIG. 25D shows an example of a cross section of the rigid profile array which each of its rigid profiles can be set separately to the preferred direction. The direction setting axis (206) is set into the desired niche of the direction setting cradle (205).

The direction setting doesn't have to include a rotation axis. As an example, a soft jell can be placed inside a cavity that holds the continuous profile module and after setting the profile in the proper angle, the jell can be radiated at in order to harden it and fix the angle of the continuous profile module.

The continuous profile modules as described here is one way, set as an example, to mount PV cells in rows, whereas each vertical group of PV cells (i.e. a column of PV cells) are connected in parallel (with a minimum of one PV cell per such cross section, but 2 PV cells, 3 PV cells, 4 PV cells or more can also be used). Each vertical group is connected in a series connection to the next vertical group, whereas all the cross sections are facing similar direction. When these rows are mounted in parallel on a deployment surface with a similar distance between them, (or no distance at all in the case of V-shape profiles for example), it creates a solution for self-shading in which whenever there is a shadow cast by one row on another row, this shadow is of similar size and shape for all the rows, except for the first row facing the sun, and possibly some edges of rows in a few sun angles. The definition of similar self-shading as used herein include cases in which a few PV cells at some of the edge of the rows get more photons than the PV cells in the middle of the rows. This is also relevant for PV cells at the edges of the continuous profile modules. It is important to note that slightly additional light on a few PV cells doesn't create much damage since the extra power they generate is small and can be easily handled by other PV cells. However, as mentioned before, slightly more shadow on a few PV cells may result in reducing the power for the entire string of PV cells.

Additional advantages in the designs presented here are:

The rotation axis on which some of the solutions here are rotating, and the rotating mechanism, are positioned behind the PV cells on the continuous profile module, thus no surface is wasted without PV material, and there is no need of a frame to hold it, so the length of the continuous profile module is not limited and there is no need to split a long deployment for the sake of mechanically strengthening the profile, as depicted in FIG. 25E.

FIG. 25E shows a close-up of the bottom side of the rigid profile. The Fig. shows how the bases (160) can be located close to each other as much as needed to strengthen the system against extreme weather conditions such as strong wind. It also shows how the rotating axis of the positioning system (123) is a one long axis that can connect to the base cradle (which contains the rotating axis of the positioning system (157)) in any distance desired for the same purpose. The angle setting basis (124) is also as long as needed without limitations and supports the whole rigid profile. So, there is no limit to how long the continuous profile module can be, continuously without interruption for electrical wires or mechanical support, and without a need of a frame to support it mechanically.

Continuous profile modules can be also mounted on walls. The unlimited length of the continuous profile module can support deployment along fences, railways and other lengthened infrastructure without connecting cables between small modules like with PV panels, but rather generating the entire required voltage with one long module.

FIG. 25F demonstrates how the current moves through two continuous profile modules (264) forward and backward, that are connected by a connector (135) on the right side, and connected to a central power line (262) through optimizer or micro-invertor (263) on the other side. The continuous profile modules (264) can be of any length according to the required voltage and the length of the deployment surface (not shown in this Fig.). Two sealed PV modules can also reside on the same profile, creating similar advantage.

One of the advantages of a flexible continuous profile module is the ability to automate the deployment process. An example for a robotic machine that automatically deploys it can be seen in FIG. 26A.

FIG. 26A shows a robotic machine (250) that automatically deploys flexible continuous profile module that initially is rolled on a roll (251) and after the process it is deployed on the surface (252). The robotic machine (250) can automatically cut the continuous profile module during the deployment to fit the size of deployment surface. Instead of the continuous profile module the system can deploy only PV cells strip or sealed PV module on a base structure that will be prepared in advance. Another type of robotic machine can deploy the base structure as preparation for this.

The length of the different continuous profile modules doesn't have to be the same in order to tilt or rotate them, which is another advantage of this invention. This fact and the unlimited length of the continuous profile modules enables setting it diagonally at different lengths on a roof to better accommodate different roof slope directions relative to the absorption direction (136), as detailed in FIG. 26B. Diagonally on the roof is this document means mounted parallel to the roof, but not parallel or vertical to the ground.

FIG. 26B demonstrate how flat profiles (229) can be positioned on different slopes of the roof in different diagonal angles in order to best accommodate the absorption direction (136).

Another important embodiment of this invention is a method to position the continuous profile modules in the most effective way. If the roof slope is not facing exactly south or north, the best way to position the profiles is diagonally, and not parallel to the ground. The exact best angle of the diagonal is dependent on the exact angle direction to which the roof slope is facing and its gradient towards the ground (or steepness), as well as the geographic latitude, which impacts the absorption direction. The ideal scenario is to set the profiles so they are facing the absorption direction (i.e. perpendicular to the absorption direction). Since its sometimes more cost effective to deploy the continuous profile modules in an angle which is a few degrees away from facing the absorption direction due to roof structure, the term facing as used herein can be with variation tolerances of up to 10 degrees, and so is perpendicular to the absorption direction.

This way the profiles are facing the absorption direction even when deployed on roof slopes which are facing east or west to some degree.

The same diagonal settings can also the best way to position the profiles when seasonal tracking is used. Seasonal tracking means that the profile is tracking vertically the short-term absorption direction on a daily basis, weekly basis, monthly basis, twice a year or any other time resolution. Seasonal tracking doesn't have to utilize an engine, but can be set manually, especially if the change is done with a low rate, such as twice a year.

If the tracking feature is utilized for rotating profiles (i.e. tracking the sun's movements during the day from morning to evening, which can be done horizontally or vertically), the diagonal direction may be different than the angle of the static profile's direction on the same roof. A continuous profile module as in FIG. 21A will be positioned for daily tracking in an angle which is facing the absorption direction, but with the ability to tilt east and west, as depicted in FIG. 26C. This way the tracking is done around a typical tilting angle which is set according to the absorption direction, increasing significantly the tracking efficiency.

FIG. 26C explains how a tilted roof (223) is used to enable tracking around the typical tilting angle (131). The arrays of the flat profiles (229) are positioned to best face the absorption direction (136) by attaching them diagonally to the roof in a way that creates the typical tilting angle (131), while maintaining their ability to rotate east-west. The array on the left was tilted to face east to best receive the sun light beam (100) in the morning. During the day, the array is rotating to track the sun from east to west, until it reaches the position of the array on the right which is tilted to face the sun light beam (100) in the evening coming from the west.

One of the advantages of this solution is that the further away from the equator you go, the more tilted are the roofs on average due to weather conditions (e.g. snow), and so is the typical tilting angle that is required for the diagonal profile, so there is a good match between the two.

This way the same type of continuous profile module can effectively track the sun on one axis on a tilted roof (horizontally) and on a flat roof (vertically or horizontally, whichever is more effective according to the distance from the equator).

A method to deploy south-facing diagonal profiles at the typical tilting angle on a tilted roof is illustrated in FIG. 26D: the roof is measured and its 3-dimensional model is registered that may include some or all of the relevant design parameters, such as direction, size, shape, dimensions and steepness of each slope. Another input is the typical tilting angle (131) of a PV panel at that latitude and its direction, as demonstrated with the reference PV panel (230). Then an imaginary flat surface (267) with the same typical tilting angle (131) directed to the same direction as the reference PV panel (230) is placed virtually on the tilted roof (223) in a way that creates cross-section borders (231) with each slope of the tilted roof (223). The flat profiles (229) are then mounted in parallel to the cross-section border line (231) of each roof slope with the imaginary surface (267). This way all the flat profiles are facing the absorption direction (136) at the typical tilting angle (131).

In case of a horizontally tracking system, the flat profiles will be positioned at 90 degrees relative to the static profiles in FIG. 26D, so they can rotate from east to west every day, as depicted in FIG. 26C.

In case of a vertically tracking system, the flat profiles will be positioned at the same angle as in FIG. 26D, so they can rotate vertically during the day.

There is also an option to avoid diagonal optimization If the continuous profile module enables 2 axis tracking.

The whole array of the continuous profile modules can be combined with a flexible base which can be also assembled in the factory or in a warehouse to fit the size, direction and slope of each side of the deployment surface (e.g. roof) after taking measurements beforehand, then folded or rolled like a carpet and taken to the deployment location. The measurements can include some or all relevant parameters, such as direction, size, shape, dimensions and steepness of each slope, as well as the geographic location in order to calculate the absorption direction. When the truck with the system arrives at the deployment location, the whole system can be placed by a crane in one piece on each slope of the roof or on two slopes together, as depicted in FIG. 26E, and then gradually unrolled while each continuous profile module is connected to the roof on its turn or at the end (the connection can be only for each 2nd continuous profile module while skipping one in between, or skipping any other number). This deployment method can save time, money and human errors during deployment.

FIG. 26E shows how a crane (210) can place a rolled carpet (211) of continuous profile modules with flexible base on top of a deployment surface (242). The second step is to unroll the carpet gradually and during this process connect each continuous profile module in its turn to the deployment surface (242).

Additional advantage of the continuous profile module is that thanks to its continuous structure, there is an option for a cleaning robot to ride on it from one side of the roof to another without interruption like a train on a track. Such robot can use electricity from the continuous profile modules for its operation or have its own PV surface as a power source and act fully autonomous. An option for such a robot for automatic cleaning can be seen in FIG. 27A.

FIG. 27A shows an example for a cleaning robot (199) that use the continuous profile module as a track for moving and cleaning. It includes 3 cleaning brushes (200) connected to an engine (201) that rolls them when operated, and their movement can also move the robot along the continuous profile module. If needed they can roll in opposite directions.

The chain connection between the engine and the brushes can't be seen in this Fig. because of its perspective. The engine (201) is connected by electrical wires (207) to the electronic controller that includes a buttery (202) which is connected to a buttery (203) by electrical wires (195) as well. The cleaning robot has 3 support wheels (204) that are griping the flat profile from the other side, as depicted in FIG. 27B.

FIG. 27B shows the cleaning robot (199) on rigid profile from the back side and FIG. 27C shows it from the front, with a small, dedicated PV panel (208) that generates the operation power of the robot (199).

The cleaning robot can have a dedicated PV cell (208) to generate energy for its operation, (as depicted in FIG. 27C), or it can use the electromagnetic field of the rigid profile to absorb energy for its operation or any other power element, including gas or water heated by the sun. Any moving technology and elements can be used, like wheels, air pressure or using the brushes movement to move the robot along the continuous profile module. Any cleaning technology and elements can be used, such as brushes, air pressure and water pressure, electrical ionization, etc. The robot can park during day time on a docking station at a dummy edge of the rigid profile where it will not cast shadow on any part of the PV surface. Any griping technology and elements can be used, such as the griping wheels, griping slide and griping niche. The control unit can be mechanical or electronic or any other control element.

Other ways to maintain the system as clean as possible are to place the profiles at a vertical position during nighttime (first option), so any dirt will be washed out by rain or by dew. This can also be done when there is a hail alert in order to minimize the risk of the system breaking from hail. The second option is to turn the profiles to an horizontal position during nighttime to collect dew. Further, a little time before sunrise, the profiles can be turned vertically so the dew will wash out the dirt. Another option is to connect the computer that controls the tracking to a weather sensor and change the cleaning plan accordingly (e.g. use the 1st option during rainy nights and the second option during humid nights or any other combination of them) Another way to mitigate the hail problem is to build the continuous profile module with flexibility. Advantageously, in this embodiment the profile module can absorb some of the impact of hail, as depicted in FIG. 27D.

FIG. 27D shows the flat profile (229) with built-in flexibility to absorb some of the impact of hail. The rotation axle unit (243) includes a built-in spring (268) that slides into the rail (244) and can absorb some of impact of hail so it doesn't heart the sealed PV module (156).

The continuous profile module can support more than one angle of PV surface in any cross section, as demonstrated in the V-shape profile, where there are 2 angles of PV surfaces at any cross section. In such cases, a minimum of two PV cells is required or one PV cell that is flexible.

As mentioned before, the first row of PV cells in an array of continuous profile modules and the first row of PV panels in an array may experience a exposure to more radiation relative to the other rows, since they do have any self-shadow cast on them. This might cause some overheating there. One way to overcome this problem is to place a dummy first row without PV material, only for the purpose of casting self-shadow. Another option is to connect them to a separate electrical line that goes separately into the inverter. In case of PV panels, a third option is to use for the first row PV panels that have a controller that can connect or electrically bypass some of the rows of PV cells, as described in here, and match the power generated by these PV panels to PV panels in other rows. Some of these solutions are also relevant to the tips of the continuous profile module, where different levels of self-shading can occur. For example, dummy PV cells are also an option there.

In addition, a mirror between the PV cells in such a continuous profile module can also equalize the level of shadow for all the PV cells in the profile, including the ones at the edge, while all photons that hit the mirrors are reflected back to a PV cells so no photons are lost.

This invention can be implemented at any scale according to the specific type of implementation. For example, on an electric vehicle such solution can be at minimum height, to avoid friction due to wind. On houses it may be as large as a tiles' height, for the sake of nice appearance, and on flat and commercial roofs it can be much larger in order to reduce cost per KW, and include many PV cells at any vertical cross section of the continuous profile module connected in parallel, even at the size of PV panels.

The following enumerated paragraphs provide additional non-limiting aspects of the disclosure.
1. A system to increase power generation per a given PV technology and a given deployment surface size by eliminating the self-shading problem, comprised of:
At least two rows of PV cells, whereas the rows are mounted in parallel to each other on a deployment surface
Each vertical cross section of a row includes a group of PV cells connected in parallel, with a minimum of one PV cell
The vertical group of PV cells in each vertical cross section of the row is connected in series to the group of PV cells in the next cross section
Whereas all cross sections are positioned to face similar direction
2. A system as in claim 1 whereas the distance between the rows of PV cells is similar.
3. A system as in any or all of the previous claims, whereas the PV cells are part of a continuous profile module
4. A system as in any or all of the previous claims, whereas the PV cells are part of a PV panel
5. A system as in any or all of the previous claims, whereas each vertical cross section is comprised of a column of PV cells connected in parallel with a minimum of 2 PV cells
6. A system as in any or all of the previous claims, whereas the continuous profile module can be set to accommodate different directions and slopes of the deployment surface
7. A system as in any or all of the previous claims, whereas the continuous profile module can be set in different angles to accommodate different directions and slopes of the deployment surface
8. A system as in any or all of the previous claims, whereas the continuous profile module can be connected in different heights between them to accommodate different directions and slopes of the deployment surface
9. A system as in any or all of the previous claims, whereas the PV cells are made of silicon, perovskite or PV sheets or any combination of them
10. A system as in any or all of the previous claims, whereas the continuous profile module can be set in different angles to accommodate different directions and slopes of the deployment surface and include means for mechanically locking it at a fixed angle
11. A system as in any or all of the previous claims, whereas the rows of PV cells can be tilted up to 65 degrees from the horizon
12. A system as in any or all of the previous claims, whereas the rows of PV cells can be tilted more than 90 degrees
1A. A system to increase the deployment density of PV panels while overcoming the self-shading effect, comprised of:
PV panels mounted on a deployment surface, whereas for each PV panel the PV cells in it are connected in series in each row of PV cells, and the rows of PV cells are also connected in series
Whereas a electrical bypass means is connected to at least one row of PV cells
The PV panels are mounted in parallel rows on a deployment surface, facing similar direction, whereas the distance between the rows of PV panels is similar
d. said electrical bypass means is controlled by a controller that activates said bypass according to a switching algorithm [see below]
2A. A system as in 1A whereas the algorithm activates the bypass solution if the power produced from a row of PV cells is reduced by at least a predefined threshold from the power produced by the row of PV cells above it, except for the highest row
3A. A system as in any or all of the previous A claims, whereas the PV panels have two sets of electric power lines, one for shadowed rows of PV cells and one for none shadowed rows of PV cells.
4A. A system as in claim 3A, whereas the controller switches the power of at least one row of PV cells to the shadowed power line or to the none shadowed power line according a switching algorithm
5A. A system as in any or all of the previous A claims, whereas the switching algorithm is using the power produced by the row of PV cells as a factor in the switching decision
1B. A system to increase power generation per a given PV technology and a given deployment surface size, comprised of:
   a. A continuous profile module, said module includes a PV surface
   b. A base for said continuous profile module
   c. Whereas said continuous profile module can be adjusted to different slopes and directions of the deployment surface they are mounted on
2B. A system as in 1B whereas the direction said PV surface is facing remains similar relative to the absorption direction in different slopes and directions of the deployment surface
3B. A system as in any or all of the previous B claims, whereas the direction settings of the continuous profile modules can be controlled from one point
4B. A system as in any or all of the previous B claims, whereas the continuous profile module includes 3-dimensional PV surface
5B. A system as in any or all of the previous B claims, whereas a rotation axis is connected along the lengthen dimension of the continuous profile module
6B. A system as in any or all of the previous B claims, whereas the PV surfaces are facing the same direction
7B. A system as in any or all of the previous B claims, whereas there are at least 2 PV cells in any vertical cross section of the continuous profile module connected in parallel
8B. A system as in any or all of the previous B claims, whereas the continuous profile module doesn't require any frame to hold it
9B. A system as in any or all of the previous B claims, whereas the continuous profile module has a rigid structure
10B. A system as in any or all of the previous B claims, whereas at least two continuous profile modules are mechanically connected to be set together to face a similar angle.
11B. A system as in any or all of the previous B claims, whereas said continuous profile modules are connected by at least one rod
12B A system as is any or all of the previous B claims, whereas the cross sections of the continuous profile module on a slope of the deployment surface are facing similar direction.
13B. A system as in any or all of the previous B claims, whereas the continuous profile module can be set in different angles to accommodate different directions and slopes of the deployment surface and are mechanically locked at a fixed angle
1C. A system to increase power generation per a given PV technology and a given deployment surface size, comprised of 3-dimensional PV surface which is part of a continuous profile module
2C. A system as in any or all of the previous C claims, which includes a solution for self-shading
3C. A system as in any or all of the previous C claims, whereas the solution for self-shading is based on optical elements
4C. A system as in any or all of the previous C claims, whereas the solution for self-shading is based on tracking
5C. A system as in any or all of the previous C claims, whereas the solution for self-shading is based on electrical connections
6C. A system as in any or all of the previous C claims, whereas the continuous profile module has a rigid structure
1D. A system to increase power generation per a given PV technology and a given deployment surface size, comprised of a PV surface mounted on a continuous profile module with a solution for self-shading
2D. A system as in any or all of the previous D claims, whereas the solution for self-shading is based on optical elements
3D. A system as in any or all of the previous D claims, whereas the solution for self-shading is based on tracking
4D. A system as in any or all of the previous D claims, whereas the solution for self-shading is based on electrical connections
5D. system as in any or all of the previous D claims, whereas the optical solution for self-shading has elevation slopes
6D. A system as in any or all of the previous D claims, whereas there are at least 2 PV cells in any vertical cross section connected in parallel
7D. A system as in any or all of the previous D claims, whereas two or more parallel mounted continuous profile modules are connected in series between them and connected to an optimizer in one of their sides
8D. A system as in any or all of the previous D claims, whereas two or more parallel mounted continuous profile modules are connected in series on between them and connected to a micro-inverter in one of their sides
9D. A system as in any or all of the previous D claims, whereas the PV cells are made of silicon, perovskite or PV sheets or any combination of them
1E. A system to increase power generation per a given PV technology and a given deployment surface size, comprised of a 3-dimensional PV surface with a solution to self-shading.
2E. A system as in any or all of the previous E claims, whereas the solution for self-shading is based on optical elements
3E. A system as in any or all of the previous E claims, whereas the solution for self-shading is based on tracking
4E. A system as in any or all of the previous E claims, whereas the solution for self-shading is based on electrical connections
5E. A system as in any or all of the previous E claims, whereas the solution is part of a continuous profile module
1F. A system to increase power generation per a given PV technology and a given deployment surface size, comprised of a continuous profile module with PV surface and a electrical bypass means for each cross section.
2F. A system as in 1F whereas there are at least 2 PV cells in any vertical cross section connected in parallel
3F. A system as in 1F whereas the system is based on silicon cells
1G. A system that increases power generation per a given PV technology and a given deployment surface size, comprised of a PV surface mounted on a continuous profile module which tracks the sun
2G. A system as in any or all of the previous G claims, whereas the system includes solution for self-shading
3G. A system as in any or all of the previous G claims, whereas the solution for self-shading is based on optical elements
4G. A system as in any or all of the previous G claims, whereas the solution for self-shading is based on tracking
5G. A system as in any or all of the previous G claims, whereas the solution for self-shading is based on electrical connections
6G. A system as in any or all of the previous G claims, whereas the tracking algorithm aims the PV surface to face sidewise at least 3 degrees away from the direction of the sun
7G. A system as in any or all of the previous G claims, whereas the cover of the PV surface has elevation slopes
1H. A method to increase the deployment density of PV panels while overcoming the self-shading effect, the method comprising:
   a. Connecting in parallel the vertical group of PV cells to each other in each vertical cross sections of a PV panel
   b. Connecting in series the vertical groups within the PV panel
2H. A method as in 1H whereas a vertical cross section means a column of PV cells.
3H. A method as in any or all of the previous H claims, whereas the PV panels are mounted in parallel rows on a deployment surface, facing similar direction.
4H. A method as in any or all of the previous H claims, whereas at the rows of PV panels have similar gaps between them
5H. A system as in any or all of the previous H claims, whereas the PV cells are made of silicon, perovskite or PV sheets or any combination of them
1I. A system to increase the deployment density of PV panels and increases PV absorption efficiency, comprised of:
   a. PV panels with cover glass that has lengthened shape profiles that are implemented on a transparent cover to accommodate the absorption direction or any other preferred direction.
2I. A system as in 1I whereas the lengthened shape profiles are elevation slopes
3I. A system as in any or all of the previous I claims, whereas the elevation slopes are customized to different slopes and different directions of a deployment surface
1J. A system to increase power generation per a given PV technology and a given deployment surface size, comprised of:
   a. A system with a PV surface which is tracking the sun
   b. A tracking algorithm position the PV surface to face sidewise at least 3 degrees away from the direction of the sun
2J. The system as in 1J whereas the PV surface is part of a continuous profile module
3J. The system as in any or all of the previous J claims, whereas the PV surface is 3-dimensional
4J. The system as in any or all of the previous J claims, whereas the cover of the PV surface has elevation slopes
5J. The system as in any or all of the previous J claims, whereas the system is tracking the sun on one axis
6J. The system as in any or all of the previous J claims, whereas the tracking axis enables is to track the sun throughout the day from east to west
7J. The system as in any or all of the previous J claims, whereas the tracking axis is to vertically track the changes of the short-term absorption direction throughout the year
8J. The system as in any or all of the previous J claims, whereas the system is tracking the sun on two axis direction
1K. A system to increase power generation per a given PV technology by cooling it with a transparent material, whereas the transparent material is positioned between the PV cell and the sun
2K. A system as in claim 1K whereas the cooling material that is used is liquid
3K. A system as in any or all of the previous K claims, whereas the cooling material that is used is gas
4K. A system as in any or all of the previous K claims, whereas the cooling material that is used is a mix of liquid and gas
5K. A system as in any or all of the previous K claims, whereas the cooling liquid is also used for cleaning the optical surface above the PV cell
6K. A system as in any or all of the previous K claims, whereas the cooling material is arriving to each unit from a parallel pipe
7K. A system as in any or all of the previous K claims, whereas the cooling material is maintained in a closed loop to minimize loss of cooling material
87K. A system as in any or all of the previous K claims, whereas the cooling material is maintaining optical coupling between the cover, the cooling material and the PV surface.
1M. A method to wire a PV panel, the method comprises of:
   a. Connecting 2 or more PV cells in each column of the PV panel in parallel
   b. Connecting the columns of the PV panel in series
2M. A system as in any or all of the previous M claims, whereas the PV cells are made of silicon, perovskite or PV sheets or any combination of them
1N. A system for automatic cleaning of a continuous profile module with a PV surface comprises of:
   a. At least one cleaning element
   b. At least one griping element
   c. At least one power element
   d. At least one control element
2N. A system as in any or all of the previous N claims, whereas one of its elements is acting also as a moving element that moves the system along the continuous profile module.
3N. A system as in any or all of the previous N claims, whereas a moving element is added in addition to all other elements
1O. A method for automatic cleaning of a continuous profile module with PV surface comprises of a cleaning robot that use the continuous profile module as a moving track
1P. A method for tracking the sun to increase power generation per a given PV technology and a given deployment surface size, comprised of:
Directing the PV surface to face sidewise at least 3 degrees away from the sun direction
1Q. A method for deploying a PV system based on continuous profile modules, comprised of:
   a. Measuring the deployment surface parameters
   b. Assembling all the continuous profile modules with a flexible base to carpets of continuous profile modules at the size of each slope of the deployment surface and rolling or folding them
   c. Placing the carpet on one side of the deployment surface and unrolling or unfolding it while mounting it on the deployment surface
2Q. A method as in 1Q whereas for each slope there is a separate base carpet and a separate module carpet
1R. A method for deploying PV panels on a curved surface to avoid self-shading effect, comprised of:
   a. Mounting the PV panels in a way the self-shading is similar for all the rows of the panels except for the first row
   b. Whereas the PV cells in each vertical cross section are connected in parallel
2R. A method as in 1R whereas the method is further comprised of:
   c. Mounting the first PV panel on the side of the curved surface which is facing the sun
   d. Mounting the next PV panel behind it (2^{nd} PV panel) at a distance in which there will be no shadow cast on the next PV panel during Zenit
   e. Mounting the rest of the PV panels at a distance in which the shadow on each of them will be similar to the shadow on the 2nd PV panel at any given time
1S. A method for deploying continuous profile modules, comprised of:
   a. Mounting the continuous profile modules in diagonal direction on the deployment surface
2S. A method as in any or all of the previous S claims, whereas the diagonal direction on the deployment surface enable the PV surface to face the absorption direction
3S. A method as in any or all of the previous S claims, whereas the mounting is done in different angle for each slope of the deployment surface.
1T. A system for trapping a light beam from many angles, comprised of:
   a. A continuous profile module, made as a V-shape with one side of the V covered by PV cell and the other side acting as a mirror.
   b. Whereas the V angle is less than 40 degrees.
1U. A system for connecting continuous profile modules which include PV surface in a row, comprised of:
   a. Mechanical connection
   b. Electronic connection
1V. A method for extending continuous profile modules, by connecting two continuous profile modules in a row, comprised of:
   a. Connecting them mechanically
   b. Connecting them electronically
1W. A system with PV surface that can be set to a desired direction on any roof slope, comprised of:
   a. a PV surface mounted on at least one rigid element
   b. at least one base unit
   c. a means to lock the angle of the rigid element
   d. whereas said rigid element is connected along its lengthen dimension to at least one base unit
   e. whereas the rigid element can be rotated to the desired direction
2W. A system as in any or all of the previous W claims, whereas the rotation is done on one axis
1X. A method for manufacturing continuous sealed PV module comprises of:
   a. A lamination machine receives PV cells and continuous sheet of capsulation material, creating a continuous capsulation sandwich
   b. Whereas the machine heats up a section of the capsulation sandwich while pressing it
2X. A method as in 1X, whereas the machine is a roll-based lamination machine
3X. A method as in any and all X claims, whereas a layer of glass tiles is added to the capsulation sandwich.
4X. A method as in any and all X claims, whereas the capsulation sandwich includes a folded layer.
5X. A method as in any and all X claims, whereas the machine is a weight-based lamination machine
1Y. A method to cut and set a continuous sealed PV module according to the required length comprised of:
   a. Cutting the continuous sealed PV module between 2 PV cells
   b. Install a connector that connects to the edge of the sealed PV module both electronically and mechanically
2Y. A method as in 1Y whereas glass tiles are attached to the continuous sealed PV module to create a continuous PV cell strip
1Z. A system for eliminating self-shading from causing a shading effect comprised of:
   a. An array of PV cells
   b. At least 2 base units
   c. Whereas the PV cells are attached to the base units in parallel mounted rows
   d. Whereas the rows of PV cells have the same gaps between them and the same orientation.
2Z. A system as in claim 1Z whereas the rows of PV cells can be mechanically locked in a fixed angle that doesn't enable them to tilt more than 10 degrees to either side
3Z. A system as in any or all of the previous Z claims, whereas the rows of PV cells can be tilted more than 90 degrees
4Z. A system as in any or all of the previous Z claims, whereas the rows of PV cells can be tilted to track the daily movement of the sun
5Z. A system as in any or all of the previous Z claims, whereas the rows of PV cells can be tilted to track the short-term absorption direction
6Z. A system as in any or all of the previous Z claims, whereas the rows of PV cells have one PV cell in each vertical cross section of the row and each PV cell is connected in series to the next PV cell in that row
7Z. A system as in any or all of the previous Z claims, whereas the rows of PV cells have at least two PV cells in each vertical cross section connected in parallel, and vertical cross sections of PV cells is connected in series to the next vertical cross section of PV cells
8Z. A system as in any or all of the previous Z claims, whereas the rows of PV cells are held along their lengthened dimension
9Z. A system as in any or all of the previous Z claims, whereas the rows of PV cells have at least 2 different lengths in each slope of the deployment surface
10Z. A system as in any or all of the previous Z claims, whereas the electrical connection is not through the rotating axis
11Z. A system as in any or all of the previous Z claims, whereas the rows of PV cells can be tilted to track the movement of the sun during the day on a horizontal axis
12Z. A system as in any or all of the previous Z claims, whereas the PV cells are made of silicon, perovskite or PV sheets or any combination of them
13Z. A method as in any or all of the previous Z claims, whereas the rows of PV cells can be tilted up to 65 degrees from the horizon
14Z. A system as in any or all of the previous Z claims, whereas the rows of PV cells can be tilted to track the movement of the sun during the day on a vertical axis
1AA. A method for eliminating self-shading from causing a shading effect comprised of:
   a. Deploying array of PV cells whereas the PV cells are set in parallel mounted rows
   b. Whereas the rows have the same gaps between them
   c. Whereas all the PV cells are tilted at the same fixed angle and the same fixed direction.
2AA. A method as in claim 1AA whereas the PV cells are at a fixed angle which position them at least 5 degrees away from being parallel to the roof slope.
3AA. A method as in any or all of the previous AA claims, whereas the rows of PV cells can be tilted up to 65 degrees from the horizon
4AA. A method as in any or all of the previous AA claims, whereas the rows of PV cells can be tilted to track the movement of the sun during the day on a vertical axis
5AA. A method as in any or all of the previous AA claims, whereas the rows of PV cells can be tilted to track the short-term absorption direction
6AA. A method as in any or all of the previous AA claims, whereas the rows of PV cells have one PV cell in each vertical cross section of the row and PV cells are connected in series to the nearby PV cells in that row
7AA. A method as in any or all of the previous AA claims, whereas the rows of PV cells have a vertical group of two or more PV cells in each vertical cross section connected in parallel, and each vertical group of PV cells is connected in series to the next vertical group of PV cells
8AA. A method as in any or all of the previous AA claims, whereas the rows of PV cells are held along their lengthened dimension
9AA. A method as in any or all of the previous AA claims, whereas the rows of PV cells have at least 2 different lengths in each slope of the deployment surface
10AA. A method as in any or all of the previous AA claims, whereas the electrical connection is not through the rotating axis
11AA. A method as in any or all of the previous AA claims, whereas the rows of PV cells can be tilted to track the movement of the sun during the day on a horizontal axis
12AA. A method as in any or all of the previous AA claims, whereas the PV cells are made of silicon, perovskite or PV sheets or any combination of them
13AA. A method as in any or all of the previous AA claims, whereas the rows of PV cells can be tilted to track the movement of the sun during the day on a vertical axis
14AA. A method as in any or all of the previous AA claims, whereas the rows of PV cells can be mechanically locked at a fixed angle that doesn't enable them to tilt more than 10 degrees to either side
16AA. A method as in any or all of the previous AA claims, whereas the rows of PV cells can be tilted more than 90 degrees
1AB. A method for deploying continuous profile modules on a curved surface to avoid self-shading effect, comprised of:
   a. Mounting the continuous profile modules in a way the self-shading is similar for all the rows of the panels except for the first row
2AB. A method as in 1AB whereas the method is further comprised of:
   b. Mounting the first continuous profile module on the side of the curved surface which is facing the sun
   c. Mounting the next continuous profile module behind it (2^{nd} continuous profile module) at a distance in which there will be no shadow cast on the next PV panel during Zenit
   d. Mounting the rest of the continuous profile modules at a distance in which the shadow on each of them will be similar to the shadow on the 2^{nd} continuous profile module at any given time
1AC. A system for covering a roof with high efficiency PV cells including continuous profile modules deployed at the same angle relative to the absorption direction.
2AC. A system as in 1AC whereas the continuous profile modules can be cut at any length between vertical groups of PV cells and connected to a connector
3AC. A system as in 2AC whereas the PV cells are positioned at least 5 degrees away from parallel to the roof slope
1AD. A method for covering a roof with high efficiency PV cells including deploying continuous profile modules at the same angle relative to the absorption direction
2AD. A method as in 1AD whereas the continuous profile modules can be cut at any length between vertical groups of PV cells and connected to a connector
3AD. A method as in 2AC whereas the PV cells are positioned at least 5 degrees away from parallel to the roof slope
1AE. A system for covering a roof with high efficiency PV cells mounted in rows which their vertical cross section includes at least one PV cell, whereas the PV cells are positioned at least 5 degrees away from parallel to the roof slope
2AE. A system as in any and all AE claims whereas the PV cells are positioned in an angle which is less than 65 degrees from the horizon
3AE. A system as in any and all AE claims whereas the vertical group in each vertical cross section of a row includes a minimum of two PV cell
4AE. A system as in any and all AE claims whereas the vertical cross section of a row includes maximum one PV cell
1AF. A system for manufacturing continuous sealed PV module comprises of:
   1. A lamination machine that receives PV cells and capsulation material, creating a continuous capsulation sandwich
   2. Whereas the machine heats up a section of the continuous capsulation sandwich while pressing it
2AF. A system as in 1AF, whereas the machine is a roll-based lamination machine
3AF. A system as in any and all AF claims, whereas a layer of glass tiles is added to the continuous capsulation sandwich.
4AF. A system as in any and all AF claims, whereas the continuous capsulation sandwich includes a folded layer.
1AG. A method for manufacturing sealed PV module while protecting its edges comprises of:
a. Folding a protection layer around at least one edge of the PV cell
b. Executing lamination process
1AH. A method for manufacturing continuous sealed PV module comprises of:
   1. A lamination machine receives PV cells and capsulation material, creating a continuous capsulation sandwich
   2. Whereas the machine press on a section of the continuous capsulation sandwich during the lamination process
2AH. A method as in 1AH, whereas the machine is a roll-based lamination machine
3AH. A method as in any and all AH claims, whereas a layer of glass tiles is added to the continuous capsulation sandwich.
4AH. A method as in any and all AH claims, whereas the continuous capsulation sandwich includes a folded layer.
1AI. A PV module comprising:
A sealed PV module wherein said module comprising at least one sealing layer on each side of said module, whereas each vertical cross section of the module includes a column of one PV cell or more PV cells connected in parallel, whereas said columns are connected in series, such that said module can be cut between each two groups of cells such that an electrical connection can be made at said cut.
2AI. A module as in claim 1Al whereas a connector is connected the said cut
3AI. A module as in any and all previous AI claims whereas the PV cells are made of silicon
4AI. A module as in any and all previous AI claims whereas the PV cells are covered with glass tiles
1AJ. A method to manufacture a continuous PV cell strip, comprised of:
Manufacturing a strip of PV cells electrically connected with minimum of one PV cell per cross section of the strip
deploying at least one sealing layer covering all sides of the strip
cutting the strip at the required length between any two of said columns of cells such that an electrical connection can be made at said cut.
2AJ. A method as in claim 1AJ whereas the module is rigid to enable connecting it to any angle of deployment surface
3AJ. A method as in any and all previous AJ claims whereas the PV cells are made of silicon
4AJ. A method as in any and all previous AJ claims whereas the PV cells are covered with glass tiles
1AK. A PV system installed on a deployment surface, said system comprising:
a plurality of modules of PV cells, each comprising:
   a plurality of PV cells arranged in a row;
   at least one PV cell in each vertical cross section of the row of said cells, whereas if there is a vertical group of more than one PV cell in each vertical cross section said cells in said vertical group are connected in parallel
said groups of said cells electrically connected in series between them; and
at least two base units connected along the lengthen dimension of said modules for orienting said modules to a selected direction and position them parallel to each other at the same distance between them
wherein said modules having common angle relative to an absorption direction,
2AK A module as in claim 1AK wherein said modules arranged such that the amount of solar illumination on most said vertical groups of said cells is similar in self-shading conditions
3AK. A module as in any and all previous AK claims whereas the PV cells are made of silicon
4AK. A module as in any and all previous AK claims whereas the PV cells are covered with glass tiles

1-21. (canceled)

22. A photovoltaic (PV) power generation system, comprising:
a mounting structure; and
two or more PV modules positioned on the mounting structure substantially parallel to one another and facing a similar direction with similar gaps between them;
wherein each module comprises a plurality of PV cell columns arranged in a row, each column comprising at least one PV cell;
wherein each PV cell in each column is electrically connected in series to an adjacent PV cell at a corresponding position in an adjacent column, forming one or more strips of PV cells connected in series;
wherein for a module having two or more strips, the strips are electrically connected together in parallel; and
wherein for each column, under a similar level of shading, said arrangement and electrical connections of the PV cells cause a similar reduction in power generation, such reduction being proportional to the level of shading.

23. The system of claim 22, wherein the gaps between adjacent modules are condensed such that, on at least one day of the year, a shadow of a module is cast on an adjacent module at daily zenit.

24. The system of claim 23, wherein the gaps between adjacent modules are condensed to form a three-dimensional PV structure in which the total front PV surface size of the PV structure is greater than the footprint of the PV structure by at least 1% in any possible tilting.

25. The system of claim 24, wherein the PV cells in each column of each PV module are electrically connected in parallel, and each column is connected in series to an adjacent column.

26. The system of claim 24, wherein the PV modules are arranged such that the amount of solar illumination on at least two columns of the row is similar in self-shading conditions, except in certain obtuse sun angles.

27. The system of claim 26, wherein the amount of solar illumination on most of the columns is similar for most of the day.

28. The system of claim 24, wherein at least two adjacent PV modules have different lengths.

29. The system of claim 24, further comprising a reflector configured to mirror sunlight towards PV cells.

30. The system of claim 24, wherein the system is mounted on a tilted roof slope;
and wherein the PV modules are facing a direction different than a direction that the roof slope is facing.

31. The system of claim 24, wherein two or more of the PV modules are electrically connected in parallel.

32. The system of claim 24, wherein the PV modules are mechanically connected to the mounting structure along their lengthened dimension, thereby minimizing the shadow on the PV cells.

33. The system of claim 24, wherein the PV modules are flat.

34. The system of claim 24, wherein said PV cells are facing a similar direction.

35. The system of claim 24, wherein the gaps between adjacent modules are condensed such that, on at least one day of the year, the shadow of a module is adjacent to the lower edge of the adjacent module at daily zenit.

36. The system of claim 22, wherein the gaps between adjacent modules are condensed such that the gap corresponds to the shorter of:
(i) a gap at which, on at least one day of the year, a shadow of a module is cast on an adjacent module at daily zenit, or
(ii) a gap forming a three-dimensional PV structure in which the total front PV surface size of the PV structure is greater than the footprint of the PV structure by at least 1% in any possible tilting.

37. The system of claim 23, wherein the PV cells in each column of each PV module are electrically connected in parallel, and each column is connected in series to an adjacent column.

38. The system of claim 22, wherein at least two adjacent PV modules have different lengths.

39. The system of claim 22, wherein the system is mounted on a tilted roof slope; and wherein the PV modules are facing a direction different than the direction to which the roof slope is facing.

40. The system of claim 36, wherein the PV cells in each column of each PV module are electrically connected in parallel, and each column is connected in series to an adjacent column.

41. The system of claim 40, wherein the amount of solar illumination on most of the columns is similar for most of the day.
